(19) United States
(12) Patent Application Publication
(10) Pub. No.: US 2024/0323244 A1
(43) Pub. Date: Sep. 26, 2024

(54) NOTIFICATION ON OUTCOME OF 5GC RELATED ACTIONS

(71) Applicant: Telefonaktiebolaget LM Ericsson (publ), Stockholm (SE)

(72) Inventors: Antonio INIESTA GONZALEZ, Madrid (ES); Susana FERNANDEZ ALONSO, Madrid (ES); Fuencisla GARCIA AZORERO, Madrid (ES); Maria Belen PANCORBO MARCOS, Madrid (ES); Ping CHEN, Shanghai (CN); Hui YANG, Shanghai (CN)

(21) Appl. No.: 18/290,084

(22) PCT Filed: May 10, 2022
(86) PCT No.: PCT/EP2022/062700

§ 371 Date: Nov. 9, 2023

(30) Foreign Application Priority Data
May 10, 2021 (WO) PCT/CN2021/092745

(51) Int. Cl. H04L 65/611; H04L 65/1063

(52) U.S. Cl. CPC H04L 65/611; H04L 65/1063

(57) ABSTRACT

The present invention generally relates to wireless or mobile communication. More particularly, the present invention relates to a method for delivering a Session Management (SM) or User Equipment (UE) policy in a 3GPP core network. The present invention also relates to apparatus and computer program product adapted for the same purpose. According to one embodiment of the present invention, a method for configuring Session Management (SM) or User Equipment (UE) policy in a 3GPP core network, includes the following steps performed by a first network node:

sending to a second network node, a request for delivering the SM or the UE policy, wherein the request indicates a subscription to the outcome of the SM or the UE policy delivery; and receiving from the second network node, an outcome of the SM or the UE policy delivery.

### TECHNICAL FIELD

The present invention generally relates to wireless or mobile communication. More particularly, the present invention relates to a method for configuring Session Management (SM) or User Equipment (UE) policy providing in a 3GPP core network. The present invention also relates to apparatus and computer program product adapted for the same purpose.

### BACKGROUND

3GPP defines different procedures for a mobile or communications network where an Application Function (AF) requires the network to apply some actions for the future Session Management (SM) or User Equipment (UE) Policy associations for a UE or group of UEs. Then upon such AF request, the associated information is stored in the User Data Repository (UDR) by the Network Exposure Function (NEF) and lately used by the Policy Control Function (PCF) to determine the proper enforcement for the SM or UE Policy associations related with the involved UEs. The procedures include Service Specific Parameter Provision, AF Influence on traffic routing, set a Policy for a future AF session and AF request to configure IPTV multicast control.

A problematic aspect in these procedures is that if the enforcement performed by the PCF for the corresponding SM and/or UE Policy associations related with the AF request fails, the AF receives as result of the AF request sent to NEF and answer meaning that the NEF has provisioned successfully the request in the UDR, which may lead the AF to inappropriate actions since the AF receives a successful response while the enforcement of the policies has failed.

Particularly, in the Service specific parameter provisioning procedure, the UE Policies provisioning procedure performed by the PCF for the involved UE(s) may fail and the AF receives the result of the service specific parameter provisioning where the NEF informs whether the request was successfully stored in UDR. The AF can only assume that the service operation took place according to its demand and can't not react if a failure happens during the corresponding UE policy delivery procedure. Similarly, for the procedure of “Set a Policy for a future session” the PCF delivery of the corresponding URSPs to the involved UEs may fail (or an error may happen) to enable the triggering of background data traffic by the UEs according to previously negotiated BDT policy, and whether the UE is invoking the PDU session according to the validity conditions of the negotiated BDT policy.

Also, for AF influence on traffic routing procedure, the PCF may fail at the installing of the corresponding PCC rule for user plane reconfiguration or any error may happen (e.g., due non supported features in SMF, PCC rule delivery error, etc.). The AF thus cannot take alternative actions when the traffic cannot be routed as requested (change the route, terminate the AF service, log the failure, etc.).

Last, for AF request to configure IPTV multicast control, the PCF may fail at the installing of the PCC rule for IPTV multicast access control or any errors. The AF thus cannot take alternative actions when the traffic cannot be routed as requested (terminate the AF service, log the failure, etc.).

### SUMMARY

The present disclosure discloses solutions for notifying the AF about the outcome of the final AF action.

According to the disclosure, an Application Function can request being informed about the final outcome of the action initiated towards the 5GC network, that is, it gets informed on whether the UE has been properly configured according to the AF demands and/or whether the network is properly configured in order to route the traffic as previously requested. Based on the received information, the AF can take further actions (reattempt, terminate the service, log the situation, inform the UE, etc.).

In one exemplary embodiment, for specific service parameter provisioning. the AF request may include a notification reporting request for the outcome of the UE Policies delivery procedure.

In another exemplary embodiment, for Set a Policy for a future session, the AF request may include a notification reporting request for the outcome of the URSP policies delivery procedure and/or the BDT Policy status for the concerned PDU sessions.

In another exemplary embodiment, for AF Influence on traffic routing, the AF request may include a notification reporting request with the outcome of the PCC rule installation procedure by the PCF for user plane reconfiguration.

In another exemplary embodiment, for AF request to configure IPTV multicast control, the AF request may include a notification reporting request with the outcome of the PCC rule installation procedure by the PCF for IPTV configuration in the user plane.

In another exemplary embodiment, for the four procedures, when the NEF receives the notification from the PCF, it performs information mapping (identity mapping, correlation identifier mapping) and notifies the AF as requested.

A first aspect of the invention relates to a method performed by a first network node for delivering Session Management (SM) or User Equipment (UE) policy in a 3GPP core network. The method comprises the following steps: sending (510), to a second network node, a request for delivering the SM or the UE policy, wherein the request indicates a subscription to the outcome of the SM or the UE policy delivery; and receiving (520), from the second network node, an outcome of the SM or the UE policy delivery.

In some embodiments, the first network node is an Application Function (AF) node, and the second network node is a Network Exposure Function (NEF) node.

In some embodiments, the delivery is of a UE policy, and the request is sent to the NEF node and includes: service specific parameters to be provisioned in the 3GPP core network; service description for identifying a service which the service specific parameters are applied to; target UE(s) indicating a UE or a group of UEs which the service specific parameters shall be delivered to by a Policy Control Function (PCF) node; and subscription to a notification on an outcome of UE policy delivery procedure as the outcome of configuring the UE policy.

In some embodiments, the delivery is of a UE Route Selection Policy (URSP), and the request is sent to the NEF node and includes service description for identifying an AF; service parameters on application guidance for URSP determination; a UE, a group of UEs or any UE which the request is associated with; and subscription to a notification on an outcome of URSP delivery procedure as the outcome of configuring the SM or the UE policy.

In some embodiments, the service parameters consist of a list of rules that associate an application traffic descriptor with requested features for PDU session(s) used by an application traffic.

In some embodiments, the service parameters including: an application traffic descriptor corresponding to URSP Traffic Descriptor; and one or more sets of Route selection parameters, each corresponds to: (DNN, S-NSSAI) provided by the first network node or determined by the second network node based on an AF Identifier; a default Route selection precedence value to be used for an application traffic when Route selection precedence with a corresponding spatial validity condition is not provided; route selection precedence with the corresponding spatial validity condition that indicates where the Route selection parameters are applied.

In some embodiments, the delivering is used for AF influence on traffic routing, and the request is sent to the NEF node or a PCF node and includes subscription to a notification on an outcome of Policy Control Charge (PCC) rule installation procedure for user plane reconfiguration as the outcome of configuring the SM or the UE policy; and an indicator on where the first network node desires to receive the notification.

In some embodiments, the delivering is used for setting a Background Data Transfer (BDT) policy for a future AF session, and the request is sent to the NEF node and includes subscription to a notification on status of the BDT policy as the outcome of configuring the SM or the UE policy; and an indicator on where the first network node desires to receive the notification.

In some embodiments, the delivering is used for configuring IPTV multicast control, and the request is sent to the NEF node and includes subscription to a notification on an outcome of PCC rule installation procedure for IPTV configuration as the outcome of configuring the SM or the UE policy; and an indicator on where the first network node desires to receive the notification.

A second aspect of the invention relates to a method performed by a first network node for delivering Session Management (SM) or User Equipment (UE) policy in a 3GPP core network. The method comprises the following steps: receiving (610), from a second network node, a request for delivering the SM or the UE policy, wherein the request indicates a subscription to the outcome of the SM or the UE policy delivery; receiving (620), from a third network node, an outcome of the SM or the UE policy delivery; and forwarding (630) the outcome of the SM or the UE policy delivery to the second network node.

In some embodiments, the first network node is a Network Exposure Function (NEF) node, the second network node is an Application Function (AF) node, and the third network node is a Policy Control Function (PCF) node.

In some embodiments, the step of forwarding comprises performing information mapping from a notification on the outcome of the SM or the UE policy delivery sent from the third network node so as to determine the AF node that subscribed to the notification; and sending the notification to the AF node.

In some embodiments, the delivering is used for service specific parameter provision and the outcome of delivering the SM or the UE policy is an outcome of UE policy delivery procedure, the method further comprising upon receiving the request, storing information of the request in a Unified Data Repository (UDR) node for being used by the third network node.

In some embodiments, the delivery is of a UE Route Selection Policy (URSP), and the outcome of delivering the SM or the UE policy is an outcome of URSP delivery procedure, the method further comprising upon receiving the request, complementing missing service parameters in the request based on local configuration.

In some embodiments, the delivering is used for AF influence on traffic routing and the outcome of configuring the SM or the UE policy is an outcome of Policy Control Charge (PCC) rule installation procedure for user plane reconfiguration, the method further comprising upon receiving the request, storing information of the request in a Unified Data Repository (UDR) node for being used by the third network node.

In some embodiments, the delivering is used for setting a Background Data Transfer (BDT) policy for a future AF session and the outcome of configuring the SM or the UE policy is status of the BDT policy, the method further comprising upon receiving the request, storing information of the request in a Unified Data Repository (UDR) node for being used by the third network node.

In some embodiments, the delivering is used for configuring IPTV multicast control and the outcome of configuring the SM or the UE policy is an outcome of PCC rule installation procedure for IPTV configuration.

A third aspect of the invention relates to a method performed by a first network node for delivering Session Management (SM) or User Equipment (UE) policy in a 3GPP core network. The method comprises the following steps: detecting (710) whether an event related to the SM or the UE policy delivery occurs; if the event occurs, generating (720) a notification on an outcome of the SM or the UE policy delivery.

In some embodiments, the method further comprises receiving (810), from a second network node or a third network node, a request for delivering the SM or the UE policy, wherein the request indicates a subscription to the outcome of the SM or the UE policy delivery; and sending (840) the notification to the second network node or the third network node.

In some embodiments, the first network node is a Policy Control Function (PCF) node, the second network node is an Application Function (AF) node, and the third network node is a Network Exposure Function (NEF) node.

In some embodiments, the delivering is used for service specific parameter provision and the outcome of delivering the SM or the UE policy is an outcome of UE policies delivery procedure.

In some embodiments, the delivery is of a UE Route Selection Policy (URSP), and the outcome of the SM or the UE policy delivery is an outcome of URSP delivery procedure.

In some embodiments, the delivering is used for AF influence on traffic routing and the outcome of configuring the SM or the UE policy is an outcome of Policy Control Charge (PCC) rule installation procedure for user plane reconfiguration.

In some embodiments, the delivering is used for setting a Background Data Transfer (BDT) policy for a future AF session and the outcome of configuring the SM or the UE policy is status of the BDT policy.

In some embodiments, the delivering is used for configuring IPTV multicast control and the outcome of configuring the SM or the UE policy is an outcome of PCC rule installation procedure for IPTV configuration.

Advantageously, when the AF is informed about an unsuccessful outcome of the initiated operation, based on the kind of received error, the AF can decide to reattempt with different conditions, terminate the service, inform the UE, etc.

Further advantageously, when the AF is informed about the successful outcome of the initiated operation, the AF can continue with the logic related to the service (inform the UE, contact specific servers, etc. with the guarantee that the 5GC/UE has accepted its demands.

Further advantageously, the AF can charge the UE properly based on the real usage of service according to the service specific conditions.

Further advantageously, the Application can be deployed appropriately according with the service provider needs.

### BRIEF DESCRIPTION OF THE DRAWINGS

The foregoing and other objects, features, and advantages of the invention would be apparent from the following more particular description of preferred embodiments as illustrated in the accompanying drawings in which:

FIG. 1 illustrates a flowchart for service specific information provisioning procedure.

FIG. 2 illustrates a flowchart for AF influence on traffic routing procedure.

FIG. 3 illustrates a flowchart for procedure for setting a policy for a future AF session.

FIG. 4 illustrates a flowchart for service specific information provisioning procedure.

FIG. 5 is a flowchart illustrating a method for configuring Session Management (SM) or User Equipment (UE) policy in a 3GPP core network according to one embodiment of the present invention.

FIG. 6 is a flowchart illustrating a method for configuring Session Management (SM) or User Equipment (UE) policy in a 3GPP core network according to another embodiment of the present invention.

FIG. 7 is a flowchart illustrating a method for configuring Session Management (SM) or User Equipment (UE) policy in a 3GPP core network according to another embodiment of the present invention.

FIG. 8 is a flowchart illustrating a method for configuring Session Management (SM) or User Equipment (UE) policy in a 3GPP core network according to another embodiment of the present invention.

FIG. 9 illustrates a processor-based implementation of a network node which may be used for implementing the above-described embodiments.

FIG. 10 illustrates a flowchart for service specific parameter provisioning procedure according to another embodiment of the present invention.

FIG. 11 illustrates a flowchart for a procedure for processing AF requests to influence traffic routing for Sessions not identified by an UE address according to another embodiment of the present invention.

FIG. 12 illustrates a flowchart for a procedure for handling an AF request targeting an individual UE address to the relevant PCF according to another embodiment of the present invention.

FIG. 13 illustrates a flowchart for a procedure for setting a policy for a future AF session according to another embodiment of the present invention.

FIG. 14 illustrates a flowchart for a procedure for AF request to provision multicast access control list information into UDR.

FIGS. 15A and 15B illustrate a flowchart for a procedure for AF request to provision Multicast Access Control List information into UDR according to another embodiment of the present invention.

FIG. 16 illustrates an example networked system in accordance with particular embodiments of the solution described herein.

### DETAILED DESCRIPTION

Before describing in detail exemplary embodiments, it is noted that components have been represented where appropriate by conventional symbols in the drawings, showing only those specific details that are pertinent to understanding the embodiments so as not to obscure the disclosure with details that will be readily apparent to those of ordinary skill in the art having the benefit of the description. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In some embodiments described herein, the term “coupled,” “connected,” and the like, may be used herein to indicate a connection, although not necessarily directly, and may include wired and/or wireless connections.

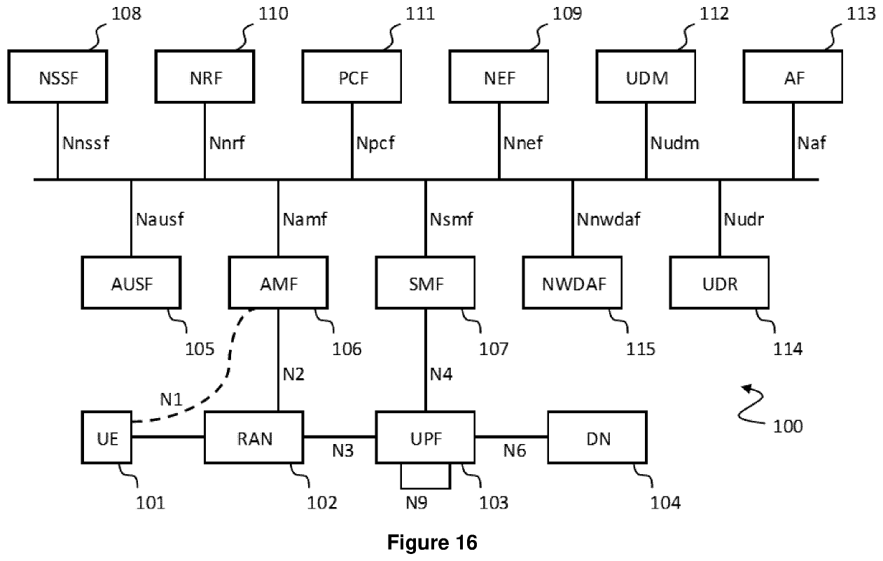

The example embodiments described herein arise in the context of a telecommunications network, including but not limited to a telecommunications network that conforms to and/or otherwise incorporates aspects of a fifth generation (5G) architecture. FIG. 16 is an example networked system 100 in accordance with example embodiments of the present disclosure. FIG. 16 specifically illustrates User Equipment (UE) 101, which may be in communication with a (Radio) Access Network (RAN) 102 and Access and Mobility Management Function (AMF) 106 and User Plane Function (UPF) 103. The AMF 106 may, in turn, be in communication with core network services including Session Management Function (SMF) 107 and Policy Control Function (PCF) 111. The core network services may also be in communication with an Application Server/Application Function (AS/AF) 113. Other networked services also include Network Slice Selection Function (NSSF) 108, Authentication Server Function (AUSF) 105, User Data Management (UDM) 112, Network Exposure Function (NEF) 109, Network Repository Function (NRF) 110 and Data Network (DN) 104. In some example implementations of embodiments of the present disclosure, an AMF 106, SMF 107, UPF 103, PCF 111, AUSF 105, NRF 110, UDM 112, NEF 109, AF 113, and NSSF 108 are each considered to be an NF. One or more additional instances of the network functions (NF) may be incorporated into the networked system.

The following relates to the Service Specific Parameter Provision procedures for enabling an Application Function (AF) to provide service specific parameters for a UE or set of UEs to 5G system via Network Exposure Function (NEF). In this procedure the NEF stores the AF request information in the User Data Repository (UDR) as “Application Data” and this information is used lately by the Policy Control Function (PCF) to determine the UE Policies applicable to the related UE or set of UEs.

This procedure is used for the provisioning of V2X policies (polices provisioned for the UE for V2X communications) for a UE or for AF guidance for UE Route Selection Policy (URSP) determination in order to route ongoing traffic.

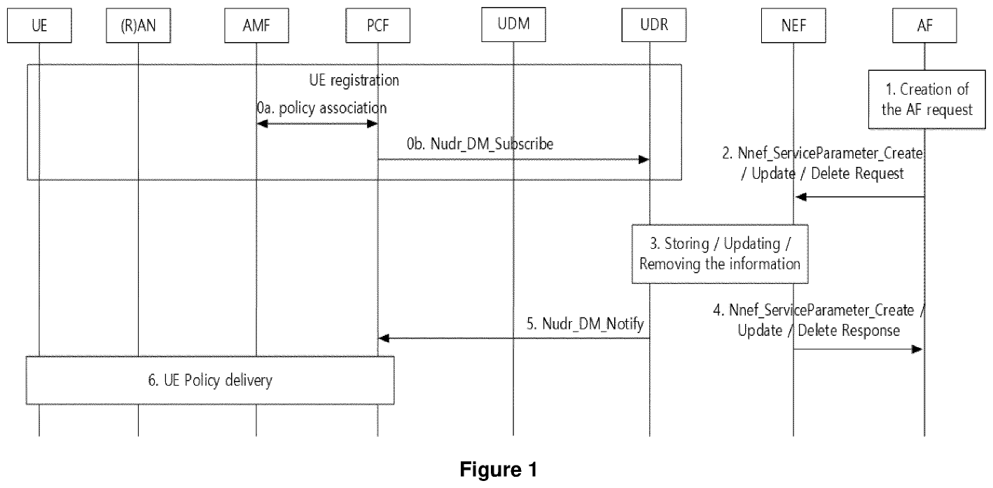

FIG. 1 illustrates a flowchart for service specific information provisioning procedure.

As shown in FIG. 1, the procedure comprises the following steps:

1. To create a new request, the AF invokes an Nnef_ServiceParameter_Create service operation.

To update or remove an existing request, the AF invokes an Nnef_ServiceParameter_Update or Nnef_ServiceParameter_Delete service operation together with the corresponding Transaction Reference ID which was provided to the AF in Nnef_ServiceParameter_Create response message.

2. The AF sends its request to the NEF. The NEF authorizes the AF request. The NEF performs the following mappings:
Map the AF-Service-Identifier into DNN and S-NSSAI combination, determined by local configuration.
Map the GPSI in Target UE Identifier into SUPI, according to information received from UDM.
Map the External Group Identifier in Target UE Identifier into Internal Group Identifier, according to information received from UDM.

In the case of Nnef_ServiceParameter_Create: The NEF assigns a Transaction Reference ID to the Nnef_ServiceParameter_Create request.

3. In the case of Nnef_ServiceParameter_Create or Update: The NEF stores the AF request information in the UDR as the “Application Data” (Data Subset setting to “Service specific information”) together with the assigned Transaction Reference ID.

In the case of Nnef_ServiceParameter_delete): The NEF deletes the AF request information from the UDR.

4. The NEF responds to the AF. In the case of Nnef_ServiceParameter_Create response message, the response message includes the assigned Transaction Reference ID.

If the UE is registered to the network and the PCF performs the subscription to notification to the data modified in the UDR by invoking Nudr_DM_Subscribe (AF service parameter provisioning information, SUPI, Data Set setting to “Application Data”, Data Subset setting to “Service specific information”) at step 0, the following steps are performed:

5. The PCF(s) receive(s) a Nudr_DM_Notify notification of data change from the UDR.

Note that PCF does not have to subscribe for each UE the application specific information, e.g. if PCF has already received the application specific information for a group of UE or for a DNN by a subscription of other UE. The same application specific information is delivered to every UE in a group or a DNN.

6. The PCF initiates UE Policy delivery.

The following relates to the AF Influence on traffic routing procedures for processing AF requests to influence traffic routing for Sessions not identified by an UE address. As part of this procedure, an Application Function may send requests to influence Session Management Function (SMF) routing decisions for User Plane traffic of PDU Sessions. The AF requests may influence User Plane Function (UPF) (re)selection and allow routing of user traffic to a local access (identified by a Data Network Access Identifier (DNAI)) to a Data Network.

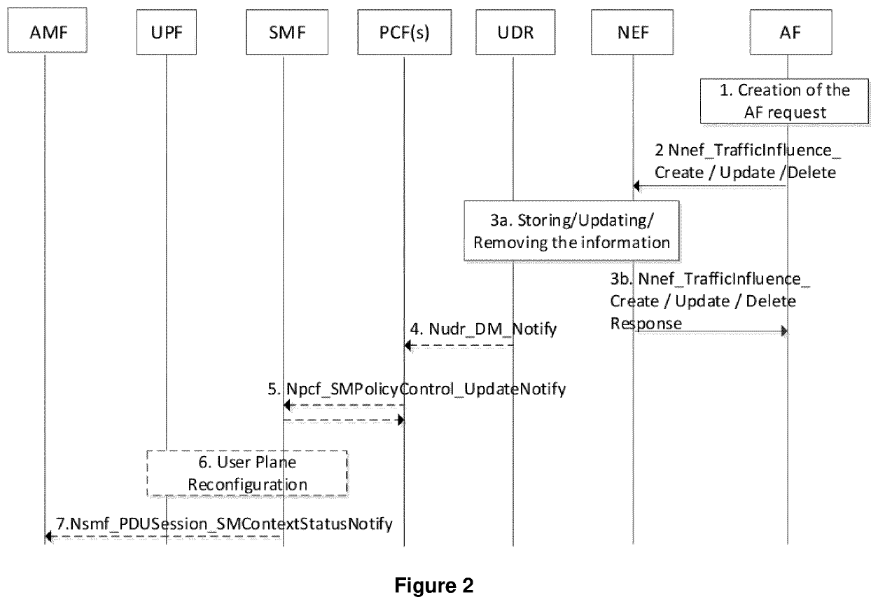

FIG. 2 illustrates a flowchart for AF influence on traffic routing procedure.

As shown in FIG. 2, the procedure comprises the following steps:

1. To create a new request, the AF invokes a Nnef_TrafficInfluence_Create service operation. The request contains also an AF Transaction Id. If it subscribes to events related with PDU Sessions the AF indicates also where it desires to receive the corresponding notifications (AF notification reporting information).

To update or remove an existing request, the AF invokes a Nnef_TrafficInfluence_Update or Nnef_TrafficInfluence_Delete service operation providing the corresponding AF Transaction Id.

2. The AF sends its request to the NEF. If the request is sent directly from the AF to the PCF, the AF reaches the PCF selected for the existing PDU Session by configuration or by invoking Nbsf_management_Discovery service.

The NEF ensures the necessary authorization control, including throttling of AF requests and, mapping from the information provided by the AF into information needed by the 5GC.

3. In the case of Nnef_TrafficInfluence_Create or Update: The NEF stores the AF request information in the UDR (Data Set=Application Data; Data Subset=AF traffic influence request information, Data Key=AF Transaction Internal ID, S-NSSAI and DNN and/or Internal Group Identifier or SUPI).

Note that both the AF Transaction Internal ID and, S-NSSAI and DNN and/or Internal Group Identifier or SUPI are regarded as Data Key when the AF request information are stored into the UDR.

In the case of Nnef_TrafficInfluence_delete: The NEF deletes the AF requirements in the UDR (Data Set=Application Data; Data Subset=AF traffic influence request information, Data Key=AF Transaction Internal ID).

The NEF responds to the AF.

4. The PCF(s) that have subscribed to modifications of AF requests (Data Set=Application Data; Data Subset=AF traffic influence request information, Data Key=S-NSSAI and DNN and/or Internal Group Identifier or SUPI) receive(s) a Nudr_DM_Notify notification of data change from the UDR.

5. The PCF determines if existing PDU Sessions are potentially impacted by the AF request. For each of these PDU Sessions, the PCF updates the SMF with corresponding new PCC rule(s) by invoking Npcf_SMPolicyControl_UpdateNotify service operation.

If the AF request includes a notification reporting request for UP path change, the PCF includes in the PCC rule(s) the information required for reporting the event, including the Notification Target Address pointing to the NEF or AF and the Notification Correlation ID containing the AF Transaction Internal ID.

The PCF may, optionally, use service experience analytics per UP path, to provide an updated list of DNAI(s) to the SMF.

6. When a PCC rule is received from the PCF, the SMF may take appropriate actions to reconfigure the User plane of the PDU Session. The SMF may consider service experience analytics per UP path (i.e. including UPF and/or DNAI and/or AS instance) before taking such actions. Examples of actions are:
Determining a target DNAI and adding, replacing or removing a UPF in the data path to e.g. act as an UL CL or a Branching Point.
Allocate a new Prefix to the UE (when IPv6 multi-Homing applies).
Updating the UPF in the target DNAI with new traffic steering rules.
Subscribe to notifications from the AMF for an Area of Interest via Namf_EventExposure_Subscribe service operation.

7. When the target DNAI(s) is received from the PCF, the SMF may decide whether it is required to send the target DNAI to the AMF for triggering SMF/I-SMF (re)selection and then inform the target DNAI information for the current PDU session or for the next PDU session to AMF via Nsmf_PDUSession_SMContextStatusNotify service operation.

The following relates to the Set a Policy for a future AF session procedures for negotiation for future background data transfer and the application of such negotiation.

As described therein, when the AF wants to apply the Background Data Transfer Policy to a future session, then the AF provides, to the NEF, the Background Data Transfer Reference ID together with the External Identifier (i.e. GPSI) or External Group Identifier of the UE(s) that are to be subject to the policy. The NEF translates the External Group Identifier into the Internal Group Identifier or the External Identifier into a SUPI. The NEF stores the Background Data Transfer Reference ID, in the UDR as Application Data Set and Background Data transfer data Subset for an Internal Group Identifier or a SUPI and the ASP id requesting to apply the Background Data transfer Policy to a future session for the UE(s). A PCF that serves the UE(s) (i.e. the PCF that serves the UE for UE Policies) may retrieve the Background Data Transfer Reference ID by retrieving the UE's Application Data from the UDR or by subscribing to notifications of changes to the UEs' Application Data in the UDR. Furthermore, the PCF retrieves the specific Background Data Transfer Policy and if available MAC address or IP 3-tuple to identify the Application server based on the received Background Data Transfer Reference ID stored as Policy Data Set from the UDR.

When the PCF determines to send the Background Data Transfer Policy information to the UE as part of a URSP rule, the PCF will store the policy in the UDR as part of the UE's Policy Set Entry and will use the associated S-NSSAI and DNN associated with the ASP id stored in the Application Data to store the Background Data Transfer Reference ID in the UE's PDU Session policy control subscription information. The PCF uses local policies to decide if and when the Background Data Transfer Policy information is going to be sent to the UE as Validation Criteria in the RSD part of the URSP rule. The UE uses Validation Criteria to determine whether or not a PDU Session should be established. The Time Window and Location Criteria are not required to be checked again during the lifetime of the PDU Session.

The AF may apply a previously negotiated policy for background data transfer to a group of UE(s) or any UE.

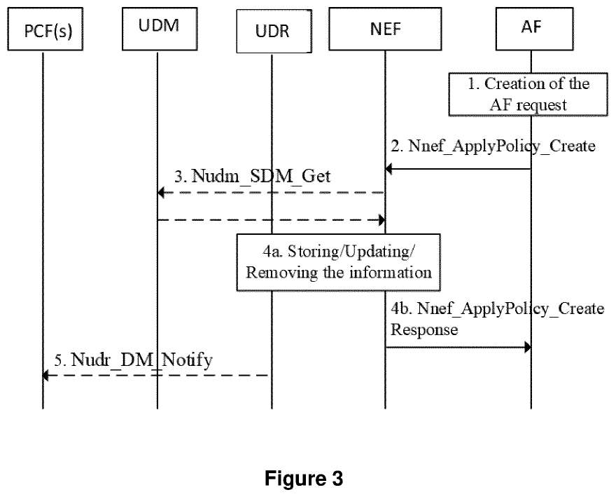

FIG. 3 illustrates a flowchart for procedure for setting a policy for a future AF session.

As shown in FIG. 3, the procedure comprises the following steps:

1. The AF previously negotiated policy for background data transfer using the Procedure for future background data transfer.

2. The AF requests that the previously negotiated policy for background data transfer be applied to a group of UE(s) or any UE, by invoking the Nnef_ApplyPolicy_Create service operation (AF Identifier, External Identifier or External Group Identifier, Background Data Transfer Reference ID). The Background Data Transfer Reference ID parameter identifies a previously negotiated transfer policy for background data transfer. The NEF assigns a Transaction Reference ID to the Nnef_ApplyPolicy_Create request. The NEF authorizes the AF request and stores the AF Identifier and the Transaction Reference ID.

3. The NEF invokes Nudm_SDM_Get (Identifier Translation, GPSI) to resolve the GPSI (External Identifier) to a SUPI or the NEF requests to resolve the External Group Identifier into the Internal Group Identifier using Nudm_SDM_Get (Group Identifier Translation, External Group Identifier).

4a. The NEF stores the AF request information in the UDR (Data Set=Application Data; Data Subset=Background Data Transfer, Data Key=Internal Group Identifier or SUPI).

4b. The NEF responds to the Nnef_ApplyPolicy_Create Request (Transaction Reference ID).

5. The PCF(s) that have subscribed to modifications of AF requests (Data Set=Application Data; Data Subset=Background Data Transfer, Data Key=Internal Group Identifier or SUPI) receive(s) a Nudr_DM_Notify notification of data change from the UDR.

The following relates to the AF request to configure IPTV multicast control procedure to enable the AF request to provision IPTV Multicast Access Control List information for a UE or group of UEs to 5G system via Network Exposure Function (NEF). In this procedure the NEF stores the IPTV configuration data in the User Data Repository (UDR) as “Application Data” and this data will be used by the Policy Control Function (PCF) to determine the Multicast Access right per UE or group of UEs

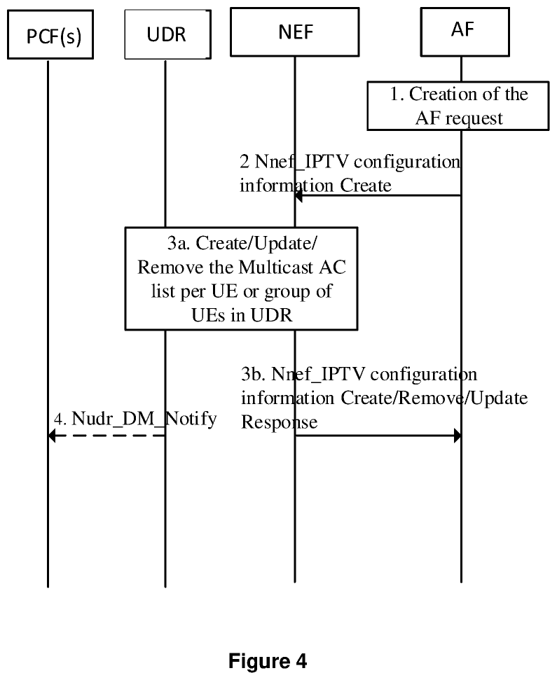

FIG. 4 illustrates a flowchart for service specific information provisioning procedure. Note that the 5GC NFs used in this scenario are assumed to all belong to the same PLMN (HPLMN).

As shown in FIG. 4, the procedure comprises the following steps:

1. To create a new request, the AF invokes an Nnef_IPTV_configuration service operation. The request contains the Multicast Access Control List, a GPSI or an External Group Id, AF Transaction Id, application identifier and may contain a DNN and/or a S-NNSAI. To update or remove an existing request, the AF invokes Nnef_IPTV_configuration_Update or Nnef_IPTV_configuration_Delete service operation providing the corresponding AF Transaction Id.

2. The AF sends its request to the NEF. The NEF ensures the necessary authorization control, including throttling of AF requests and, mapping from the information provided by the AF into information needed by the 5GC.

3. In the case of Nnef_IPTV_configuration_Create or Update: The NEF stores the AF request information in the UDR (Data Set=Application Data; Data Subset=IPTV_configuration, Data Key=AF Transaction Internal ID, S-NSSAI and DNN and/or SUPI/Internal-Group-Id).

In the case of Nnef_IPTV_configuration_Delete: The NEF deletes the AF requirements in the UDR (Data Set=Application Data; Data Subset=IPTV_configuration, Data Key=AF Transaction Internal ID).

The NEF responds to the AF.

4. The PCF(s) that have subscribed to modifications of AF requests (Data Set=Application Data; Data Subset=IPTV_configuration, Data Key=SUPI/Internal-Group-Id) receive a Nudr_DM_Notify notification of data change from the UDR.

5. The PCF determines if existing PDU Sessions are potentially impacted by the AF request. For each of these PDU Sessions, the PCF updates the SMF with corresponding new PCC rule(s) by invoking Npcf_SMPolicyControl_UpdateNotify service operation.

Table 1 shows an example of a Multicast Access Control list provided by the AF in the IPTV domain to the NEF. The Multicast Access Control List defines the access right status (i.e. fully allowed, preview allowed, not allowed) of each of the Multicast channels per subscriber identified by a GPSI.

TABLE 1
Example of a Multicast Access Control list
provided by the AF in the IPTV domain

| | IP Multicast | IP Multicast | IP Multicast |
|---|---|---|---|
| | Addressing | Addressing | Addressing |
| | information 1 | information 2 | information 3 |
| | (related to | (related to | (related to |
| | Channel 1) | Channel 2) | Channel 3) |
| GPSI 1 | Fully allowed | Not allowed | Preview allowed |

The NEF maps the GPSI into the SUPI, assigned to a 5G-RG, as described in step 2 in FIG. 4, and stores the Multicast Access Control List in the UDR as shown in Table 2.

TABLE 2
Example of a Multicast Access Control list
stored in UDR within the Application Data Set

| | IP Multicast | IP Multicast | IP Multicast |
|---|---|---|---|
| | Addressing | Addressing | Addressing |
| | information 1 | information 2 | information 3 |
| | (related to TV | (related to TV | (related to TV |
| DataKey | Channel 1) | Channel 2) | Channel 3) |
| SUPI for 5G-RG 1 | Fully allowed | Not allowed | Preview allowed |
| SUPI for 5G-RG 2 | Fully allowed | Fully allowed | Not allowed |
| SUPI for 5G-RG 3 | Fully allowed | Preview allowed | Preview allowed |

If source Specific Multicast is to be used for a TV Channel, IP Multicast Addressing information corresponds to IP Multicast address and Source IP address.

The PCF is assumed to have subscribed to relevant modifications of that UDR data defined in the Table 2.

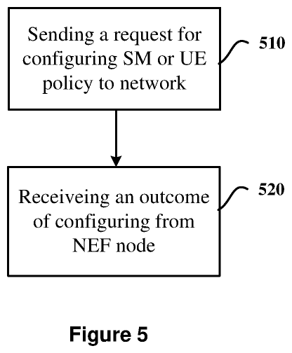

FIG. 5 is a flowchart illustrating a method for configuring Session Management (SM) or User Equipment (UE) policy in a 3GPP core network according to one embodiment of the present invention. The Core Network (CN) may include a plurality of network nodes, e.g., AMF node, UDM node, UDR node, PCF node, NEF node, NRF node, SMF node, AUSP node and AF node.

As shown in FIG. 5, at step 510, a first network node, e.g., an AF node, sends a request for configuring the SM or the UE policy to the 3GPP core network, e.g., an NEF node or a PCF node. The request is configured to subscribe to an event of configuring the SM or the UE policy.

Optionally, the configuring is used for configuring UE policy, and the request is sent to the NEF node. For example, the request may include the following information:
service specific parameters to be provisioned in the 3GPP core network;
service description for identifying a service which the service specific parameters are applied to;
target UE(s) indicating a UE or a group of UEs which the service specific parameters shall be delivered to by a Policy Control Function (PCF) node; and
subscription to a notification on an outcome of UE policy delivery procedure as the outcome of configuring the SM or the UE policy.

Optionally, the configuring is used for configuring UE Route Selection Policy (URSP) for a future session, and the request is sent to the NEF node. For example, the request may include the following information:
service description for identifying an AF;
service parameters on application guidance for URSP determination;
a UE, a group of UEs or any UE which the request is associated with; and
subscription to a notification on an outcome of URSP delivery procedure as the outcome of configuring the SM or the UE policy.

Optionally, the service parameters may consist of a list of rules that associate an application traffic descriptor with requested features for PDU session(s) used by an application traffic. As an example, the service parameters may include:
an application traffic descriptor corresponding to URSP Traffic Descriptor; and
one or more sets of Route selection parameters, each corresponds to:
(DNN, S-NSSAI) provided by the first network node or determined by the second network node based on an AF Identifier;
a default Route selection precedence value to be used for an application traffic when Route selection precedence with a corresponding spatial validity condition is not provided;
route selection precedence with the corresponding spatial validity condition that indicates where the Route selection parameters are applied.

Optionally, the configuring is used for AF influence on traffic routing, and the request is sent to the NEF node or a PCF node. For example, the request may include the following information:
subscription to a notification on an outcome of Policy Control Charge (PCC) rule installation procedure for user plane reconfiguration as the outcome of configuring the SM or the UE policy; and
an indicator on where the first network node desires to receive the notification.

Optionally, the configuring is used for setting a Background Data Transfer (BDT) policy for a future AF session, and the request is sent to the NEF node. For example, the request may include the following information:
subscription to a notification on status of the BDT policy as the outcome of configuring the SM or the UE policy; and
an indicator on where the first network node desires to receive the notification.

Optionally, the configuring is used for configuring IPTV multicast control, and the request is sent to the NEF node. For example, the request may include the following information:
subscription to a notification on an outcome of PCC rule installation procedure for IPTV configuration as the outcome of configuring the SM or the UE policy; and
an indicator on where the first network node desires to receive the notification.

At step 520, the first network node receives an outcome of configuring the SM or the UE policy from a second network node, e.g., the NEF node. Optionally, the outcome may be in form of a notification.

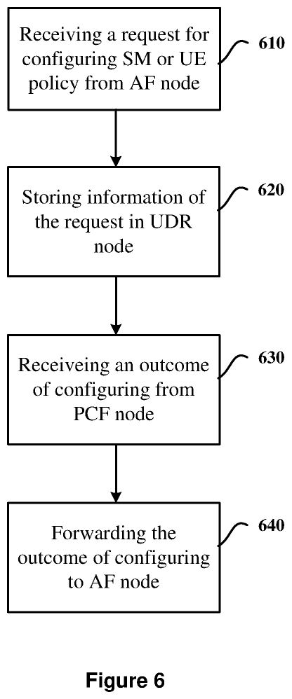

FIG. 6 is a flowchart illustrating a method for configuring Session Management (SM) or User Equipment (UE) policy in a 3GPP core network according to another embodiment of the present invention. The Core Network (CN) may include a plurality of network nodes, e.g., AMF node, UDM node, UDR node, PCF node, NEF node, NRF node, SMF node, AUSP node and AF node.

As shown in FIG. 6, at step 610, a network node, e.g., an NEF node, receives a request for configuring the SM or the UE policy from a second network node, e.g., an AF node. The request is configured to subscribe to an event of configuring the SM or the UE policy.

At step 620, the NEF node stores information of the request in a Unified Data Repository (UDR) node for being used by a third network node, e.g., a PCF node.

At step 630, the NEF node receives an outcome of configuring the SM or the UE policy from the third network node.

Optionally, the configuring is used for service specific parameter provision and the outcome of configuring the SM or the UE policy is an outcome of UE policy delivery procedure.

Optionally, the configuring is used for configuring UE Route Selection Policy (URSP) for a future session, and the outcome of configuring the SM or the UE policy is an outcome of URSP delivery procedure.

Optionally, the configuring is used for AF influence on traffic routing and the outcome of configuring the SM or the UE policy is an outcome of Policy Control Charge (PCC) rule installation procedure for user plane reconfiguration.

Optionally, the configuring is used for setting a Background Data Transfer (BDT) policy for a future AF session and the outcome of configuring the SM or the UE policy is status of the BDT policy.

Optionally, the configuring is used for configuring IPTV multicast control and the outcome of configuring the SM or the UE policy is an outcome of PCC rule installation procedure for IPTV configuration.

At step 640, the NEF node forwards the outcome of configuring the SM or the UE policy to the second network node, e.g., AF node.

Optionally, at step 640, the forwarding may be performed in the following way:

Firstly, the NEF node performs information mapping from a notification on the outcome of configuring the SM or the UE policy sent from the third network node so as to determine a target AF node.

Then, the NEF node sends the notification to the target AF node as determined.

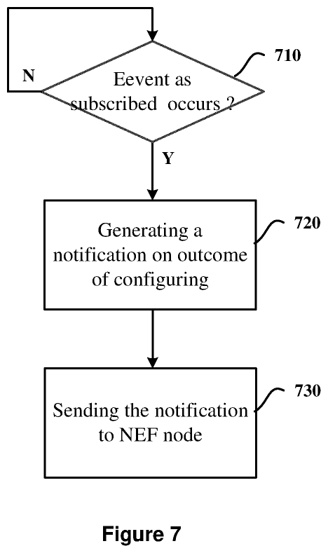

FIG. 7 is a flowchart illustrating a method for configuring Session Management (SM) or User Equipment (UE) policy in a 3GPP core network according to another embodiment of the present invention. The Core Network (CN) may include a plurality of network nodes, e.g., AMF node, UDM node, UDR node, PCF node, NEF node, NRF node, SMF node, AUSP node and AF node.

As shown in FIG. 7, at step 710, a network node, e.g., a PCF node, detects whether an event of configuring the SM or the UE policy as subscribed to by a second network node, e.g., AF node, occurs.

If the event occurs, the flowchart proceeds to step 720 where the PCF node generates a notification on an outcome of the configuring the SM or the UE policy; otherwise, the PCF node continues to detect whether the event occurs.

At step 730, the PCF node sends the notification to a third network node, e.g., NEF node, which forwards the notification to a target AF node. Optionally, the PCF node may specify a target AF node in the notification sent to the NEF node so that the NEF node may determine the target AF node by performing information mapping.

Optionally, the configuring is used for service specific parameter provision and the outcome of configuring the SM or the UE policy is an outcome of UE policy delivery procedure.

Optionally, the configuring is used for configuring UE Route Selection Policy (URSP) for a future session, and the outcome of configuring the SM or the UE policy is an outcome of URSP delivery procedure.

Optionally, the configuring is used for AF influence on traffic routing and the outcome of configuring the SM or the UE policy is an outcome of Policy Control Charge (PCC) rule installation procedure for user plane reconfiguration.

Optionally, the configuring is used for setting a Background Data Transfer (BDT) policy for a future AF session and the outcome of configuring the SM or the UE policy is status of the BDT policy.

Optionally, the configuring is used for configuring IPTV multicast control and the outcome of configuring the SM or the UE policy is an outcome of PCC rule installation procedure for IPTV configuration.

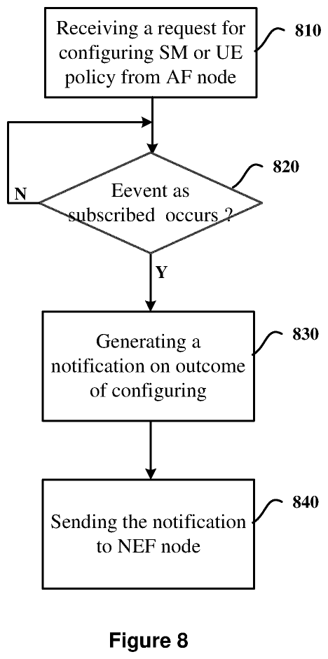

FIG. 8 is a flowchart illustrating a method for configuring Session Management (SM) or User Equipment (UE) policy in a 3GPP core network according to another embodiment of the present invention. The Core Network (CN) may include a plurality of network nodes, e.g., AMF node, UDM node, UDR node, PCF node, NEF node, NRF node, SMF node, AUSP node and AF node.

As shown in FIG. 8, at step 810, a network node, e.g., a PCF node, receives a request for configuring the SM or the UE policy from a second network node, e.g., an AF node. The request is configured to subscribe to an event of configuring the SM or the UE policy.

At step 820, the PCF node detects whether the event of configuring the SM or the UE policy occurs.

If the event occurs, the flowchart proceeds to step 830 where the PCF node generates a notification on an outcome of the configuring the SM or the UE policy; otherwise, the PCF node continues to detect whether the event occurs.

At step 840, the PCF node sends the notification to a third network node, e.g., NEF node, which forwards the notification to a target AF node. Optionally, the PCF node may specify a target AF node in the notification sent to the NEF node so that the NEF node may determine the target AF node by performing information mapping.

Optionally, the configuring is used for AF influence on traffic routing and the outcome of configuring the SM or the UE policy is an outcome of Policy Control Charge (PCC) rule installation procedure for user plane reconfiguration.

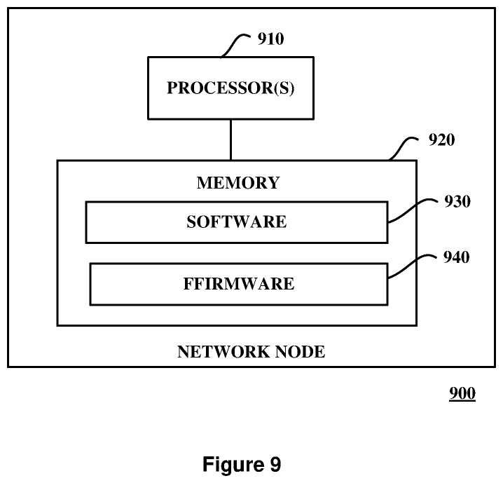

FIG. 9 illustrates a processor-based implementation of a network node which may be used for implementing the above-described embodiments. For example, the structures as illustrated in FIG. 9 may be used for implementing the concepts in the above-mentioned PCF node.

As illustrated, the node 900 may include one or more processors 910 and a memory 920 coupled to the processor(s) 910. By way of example, the processor(s) 910 and the memory 920 could be coupled by one or more internal bus systems of the node 900. The memory 920 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 920 may include software 930 and/or firmware 940. The memory 920 may include suitably configured program code to be executed by the processor(s) 910 so as to implement the above-described functionalities, such as explained in connection with FIGS. 5-8.

According to some embodiments, also a computer program may be provided for implementing functionalities of the node 900, e.g., in the form of a physical medium storing the program code and/or other data to be stored in the memory 920 or by making the program code available for download or by streaming.

The following relates to Updates for service specific parameter provisioning/Service specific parameter provisioning procedures for enabling an AF to provide service specific parameters to 5G system via NEF are described.

The AF may issue requests on behalf of applications not owned by the PLMN serving the UE.

In the case of architecture without CAPIF support, the AF is locally configured with the API termination points for the service. In the case of architecture with CAPIF support, the AF obtains the service API information from the CAPIF core function via the Availability of service APIs event notification or Service Discover Response.

The AF request sent to the NEF may include the information as below:

### 1) Service Description

Service Description is the information to identify a service the Service Parameters are applied to. The Service Description in the AF request can be represented by the combination of DNN and S-NSSAI, an AF-Service-Identifier or an application identifier.

### 2) Service Parameters.

Service Parameters are the service specific information which needs to be provisioned in the Network and delivered to the UE in order to support the service identified by the Service Description.

### 3) Target UE(s) or a Group of UEs.

Target UE(s) or a group of UEs indicate the UE(s) which the Service Parameters shall be delivered to. Individual UEs can be identified by GPSI, or an IP address/Prefix or a MAC address. Groups of UEs can be identified by an External Group Identifiers. If identifiers of target UE(s) or a group of UEs are not provided, then the Service Parameters shall be delivered to any UEs using the service identified by the Service Description.

### 4) Subscription to Events.

The AF may subscribe to notifications about the outcome of the UE Policies delivery due to service specific parameter provisioning.

The NEF authorizes the AF request received from the AF and stores the information in the UDR as “Application Data”. The Service Parameters are delivered to the targeted UE by the PCF when the UE is reachable.

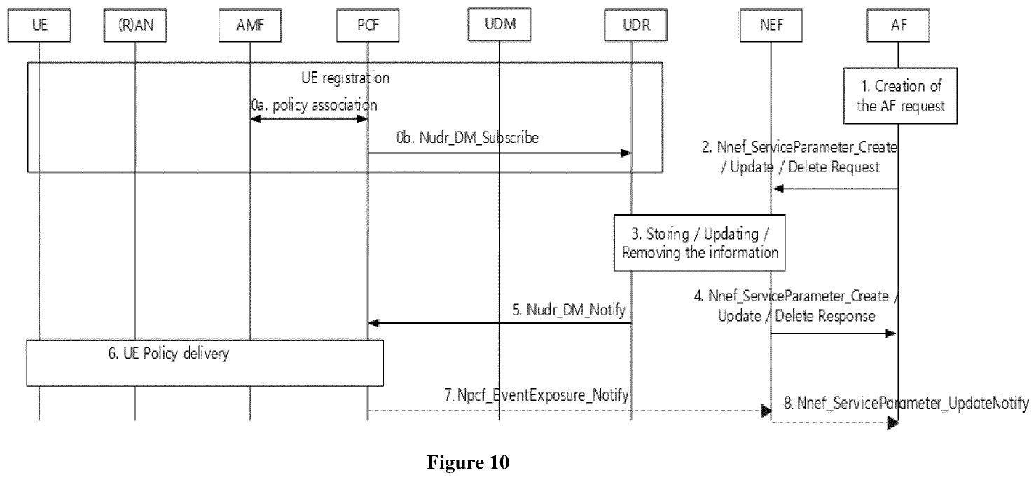

FIG. 10 illustrates a flowchart for service specific parameter provisioning procedure according to another embodiment of the present invention. In the present embodiment, the AF uses Nnef_ServiceParameter service to provide the service specific parameters to the PLMN and the UE.

The procedure comprises the following steps:

1. To create a new request, the AF invokes an Nnef_ServiceParameter_Create service operation. The request may include subscription information to the report of the outcome of UE Policy delivery.

To update or remove an existing request, the AF invokes an Nnef_ServiceParameter_Update or Nnef_ServiceParameter_Delete service operation together with the corresponding Transaction Reference ID which was provided to the AF in Nnef_ServiceParameter_Create response message.

2. The AF sends its request to the NEF. The NEF authorizes the AF request. The NEF performs the following mappings:
Map the AF-Service-Identifier into DNN and S-NSSAI combination, determined by local configuration.
Map the GPSI in Target UE Identifier into SUPI, according to information received from UDM.
Map the External Group Identifier in Target UE Identifier into Internal Group Identifier, according to information received from UDM.

If the AF subscribed to the outcome of UE Policy delivery, the NEF indicates where the NEF receives the corresponding notifications.

In the case of Nnef_ServiceParameter_Create: The NEF assigns a Transaction Reference ID to the Nnef_ServiceParameter_Create request.

3. In the case of Nnef_ServiceParameter_Create or Update: The NEF stores the AF request information in the UDR as the “Application Data” (Data Subset setting to “Service specific information”) together with the assigned Transaction Reference ID.

In the case of Nnef_ServiceParameter_delete: The NEF deletes the AF request information from the UDR.

4. The NEF responds to the AF. In the case of Nnef_ServiceParameter_Create response message, the response message includes the assigned Transaction Reference ID.

If the UE is registered to the network and the PCF performs the subscription to notification to the data modified in the UDR by invoking Nudr_DM_Subscribe (AF service parameter provisioning information, SUPI, Data Set setting to “Application Data”, Data Subset setting to “Service specific information”) at step 0, the following steps are performed:

5. The PCF(s) receive(s) a Nudr_DM_Notify notification of data change from the UDR.

Note that PCF does not have to subscribe for each UE the application specific information, e.g. if PCF has already received the application specific information for a group of UE or for a DNN by a subscription of other UE. The same application specific information is delivered to every UE in a group or a DNN.

6. The PCF initiates UE Policy delivery.

7. If the AF subscribed to notifications about the outcome of UE Policies delivery due to Service specific parameter provisioning the PCF notifies the outcome of the procedure to NEF sending Npcf_EventExposure_Notify.

8. When the NEF receives Npcf_EventExposure_Notify, the NEF performs information mapping (e.g. AF Transaction Internal ID provided in Notification Correlation ID to AF Transaction ID, SUPI to GPSI, etc.) and triggers the appropriate Nnef_ServiceParameter_Notify message.

The following relates to the Application guidance for URSP determination procedures to allow an AF to provide guidance for URSP determination to 5G system via NEF. The AF may belong to the operator or to an external party. The PCF is in the Home PLMN as it is the PCF that determines the URSP for the UE.

The operator can negotiate with external party (typically a Corporate represented by an AF) dedicated DNN(s) and/or S-NSSAI(s) for the traffic of UE(s) of this external party. UE(s) of the external party can be identified by a group identifier.

The guidance for URSP determination may be used to provide 5GC with guidance for the URSPs depending on the UE location.

For providing guidance for URSP determination, the procedure is performed with the following considerations:
1) Service Description indicates an AF Identifier.
2) Service Parameters.

Information on the AF guidance for URSP determination which consists of a list of rules that associate an application traffic descriptor with requested features for the candidate PDU sessions the application traffic may use:
An application traffic descriptor, whose definition corresponds to that of the URSP Traffic Descriptors.
one or more sets of Route selection parameters, each parameter may correspond to:
(DNN, S-NSSAI). This may be provided by the AF or determined by the NEF based on the AF Identifier when it is not provided by the AF and the AF provides only one instance of AF guidance for URSP determination
a default Route selection precedence value to be used for the application traffic when Route selection precedence with a corresponding spatial validity condition is not provided.
   Route selection precedence with a corresponding spatial validity condition that indicates where the Route selection parameters apply. This may correspond to a geographical area (i.e. geographic zone identifier).

The different sets of Route selection parameters indicate different sets of PDU Session information (DNN, S-NSSAI) that can be associated with applications matching the application traffic descriptor. Each set is meant to apply for a specific (set of) spatial validity condition. Each set is associated with a Route selection precedence to cope with the case where multiple spatial validity conditions overlap.

If the AF provides a geographical area as spatial validity condition, it is up to the NEF or PCF to transform this information into 3GPP identifiers (e.g. TAI(s)).

NEF may, based on local configuration, complement missing service parameters.

Note that AF guidance for application traffic is not related with 5G VN group.
3) a specific UE, or a group of UE(s) or any UE that the AF request may be associated with.
4) Subscription to events.

The AF may subscribe to notifications about the outcome of the UE Policies delivery due to application guidance for URSP determination.

The following relates to the Npcf_EventExposure_Notify service operation.

Service operation name: Npcf_EventExposure_Notify.

Description: This service operation reports the event to the consumer that has previously subscribed.

Inputs, Required: Event ID, corresponding UE ID (GPSI), Notification Correlation Information, time stamp.

Inputs, Optional: Event specific information.

Outputs, Required: None.

When the PCF detects the event subscribed by the NF consumer, the PCF reports the subscribed event together with the Notification Target Address (+Notification Correlation ID) to the Event Receiving NF.

The optional event specific parameter list provides the values that matched for generating the event notification. The parameter values to match are specified during the event subscription.

In the case of UE Policies change, this notification can be the result of an implicit subscription of the NEF/AF due to service specific provisioning or application guidance for URSP determination.

The following relates to the Nnef_ServiceParameter_Create operation.

Service operation name: Nnef_ServiceParameter_Create

Description: The consumer stores service specific parameters in the UDR via the NEF.

Inputs, Required: Service Descriptor (e.g. the combination of DNN and S-NSSAI, an AF-Service-Identifier or an application identifier)

Inputs, Optional: Service Parameters and Target UE identifiers (e.g. the address (IP or Ethernet) of the UE if available, GPSI if available, External Group Identifier if available), subscribedEvents, notificationDestination

If identifiers of target UE(s) or a group of UEs are not provided, then the Service Parameters shall correspond to any UEs using the service identified by the Service Description.

Outputs, Required: Transaction Reference ID, operation execution result indication.

Outputs, Optional: None.

The following relates to the Nnef_ServiceParameter_Notify operation.

Service operation name: Nnef_ServiceParameter_Notify

Description: Forwards the notification of outcome of UE Policies Delivery to AF.

Inputs, Required: Transaction Reference ID, GPSI/SUPI, Result.

The Transaction Reference ID identifies the AF request for service specific parameter provisioning that the event report is related to. The event Id may be the UE Policies delivery outcome. The GPSI/SUPI is the identifier of the UE for which the event report is related to. The Result is the result of the UE Policies delivery procedure for which event report is related to.

Inputs, Optional: DNN, S-NSSAI. additional event info (e.g. for unsuccessful results the reason).

Outputs, Required: Operation execution result indication

Outputs, Optional: None

Regarding the event reporting from the PCF, the AF may subscribe/unsubscribe to notifications of events from the PCF for the PDU Session to which the AF session is bound. Alternatively, a PCF for the UE may subscribe/unsubscribe to notifications from the PCF for the PDU Session of this UE.

The events that can be subscribed by the AF and by the PCF for the UE are listed in Table 3.

TABLE 3
Events relevant for reporting from the PCF

| | | | Availability | | | Availability | |
|---|---|---|---|---|---|---|---|
| | | | for Rx | Availability | Availability | for N43 | |
| | | Conditions | PDU | for N5 | for Bulk | per SUPI, | Availability |
| | | for | Session | per PDU | Subscription | DNN, | for N5 |
| Event | Description | reporting | (NOTE 2) | Session | (NOTE 1) | S-NSSAI | per UE |
| PLMN | The PLMN | AF | Yes | Yes | Yes | No | No |
| Identifier | identifier or | | | | | | |
| Notification | SNPN identifier | | | | | | |
| (NOTE 5) | where the UE | | | | | | |
| | is currently | | | | | | |
| | located. | | | | | | |
| Change of | The Access | AF | Yes | Yes | Yes | No | No |
| Access Type | Type and, if | | | | | | |
| | applicable, the | | | | | | |
| | RAT Type of the | | | | | | |
| | PDU Session | | | | | | |
| | has changed. | | | | | | |
| EPS fallback | EPS fallback | AF | Yes | Yes | No | No | No |
| | is initiated | | | | | | |
| Signalling | The status of | AF | Yes | Yes | No | No | No |
| path status | the resources | | | | | | |
| | related to the | | | | | | |
| | signalling traffic | | | | | | |
| | of the AF | | | | | | |
| | session. | | | | | | |
| Access | The Access | AF | Yes | Yes | No | No | No |
| Network | Network | | | | | | |
| Charging | Charging | | | | | | |
| Correlation | Correlation | | | | | | |
| Information | Information of | | | | | | |
| | the resources | | | | | | |
| | allocated for the | | | | | | |
| | AF session. | | | | | | |
| Access | The user | AF | Yes | Yes | No | No | No |
| Network | location and/or | | | | | | |
| Information | timezone when | | | | | | |
| Notification | the PDU | | | | | | |
| | Session has | | | | | | |
| | changed in | | | | | | |
| | relation to the | | | | | | |
| | AF session. | | | | | | |
| Reporting | The usage | AF | Yes | Yes | No | No | No |
| Usage for | threshold | | | | | | |
| Sponsored | provided by the | | | | | | |
| Data | AF has been | | | | | | |
| Connectivity | reached; or the | | | | | | |
| | AF session is | | | | | | |
| | terminated. | | | | | | |
| Service | The resources | AF | Yes | Yes | No | No | No |
| Data Flow | related to the | | | | | | |
| deactivation | AF session are | | | | | | |
| | released. | | | | | | |
| Resource | The outcome of | AF | Yes | Yes | No | No | No |
| allocation | the resource | | | | | | |
| outcome | allocation | | | | | | |
| | related to the | | | | | | |
| | AF session. | | | | | | |
| QoS targets | The QoS targets | AF | No | Yes | No | No | No |
| can no longer | can no longer | | | | | | |
| (or can again) | (or can again) | | | | | | |
| be fulfilled | be fulfilled by | | | | | | |
| | the network for | | | | | | |
| | (a part of) the | | | | | | |
| | AF session. | | | | | | |
| QoS | The QoS | AF | No | Yes | No | No | No |
| Monitoring | Monitoring | | | | | | |
| parameters | parameter(s) | | | | | | |
| | (e.g. UL packet | | | | | | |
| | delay, DL | | | | | | |
| | packet delay or | | | | | | |
| | round trip | | | | | | |
| | packet delay) | | | | | | |
| | are reported to | | | | | | |
| | the AF | | | | | | |
| | according to the | | | | | | |
| | QoS Monitoring | | | | | | |
| | reports received | | | | | | |
| | from the SMF. | | | | | | |
| Out of credit | Credit is no | AF | Yes | Yes | No | No | No |
| | longer available. | | | | | | |
| Reallocation | Credit has been | AF | Yes | Yes | No | No | No |
| of credit | reallocated after | | | | | | |
| | the former Out | | | | | | |
| | of credit | | | | | | |
| | indication. | | | | | | |
| 5GS Bridge | 5GS Bridge | AF | No | Yes | No | No | No |
| information | information that | | | | | | |
| Notification | has been | | | | | | |
| (NOTE 3) | received by PCF | | | | | | |
| | from SMF. | | | | | | |
| Notification | The outcome of | AF | No | No | Yes | No | Yes |
| on outcome | the request of | | | | | | |
| of service | service area | | | | | | |
| area | coverage | | | | | | |
| coverage | change. | | | | | | |
| change | | | | | | | |
| Notification | The outcome of | AF | No | No | Yes | No | No |
| on outcome | the request for | | | | | | |
| of UE Policies | UE policies | | | | | | |
| delivery | delivery due to | | | | | | |
| | service specific | | | | | | |
| | parameter | | | | | | |
| | provisioning | | | | | | |
| | procedure. | | | | | | |
| Notification | PDU session is | AF | No | No | Yes | No | No |
| on BDT | established over | | | | | | |
| Policy status | negotiated | | | | | | |
| for the | S-NSSAI/DNN | | | | | | |
| concerned | for negotiated | | | | | | |
| PDU | BDT Policy | | | | | | |
| sessions | | | | | | | |
| Notification | The outcome of | AF | No | Yes | Yes | No | No |
| on outcome | the request for | | | | | | |
| of AF | AF influence on | | | | | | |
| influence on | traffic routing. | | | | | | |
| traffic routing | | | | | | | |
| Notification | The outcome of | AF | No | No | Yes | No | No |
| on outcome | the request for | | | | | | |
| of IPTV | IPTV | | | | | | |
| configuration | configuration. | | | | | | |
| Start of | The start or the | PCF | No | No | No | Yes | No |
| application | stop of | | | | | (NOTE 4) | |
| traffic | application | | | | | | |
| detection and | traffic has been | | | | | | |
| Stop of | detected. | | | | | | |
| application | | | | | | | |
| traffic | | | | | | | |
| detection | | | | | | | |
| Satellite | The satellite | AF | No | Yes | Yes | No | No |
| backhaul | backhaul | | | | | | |
| category | category (i.e. | | | | | | |
| change | GEO, MEO, | | | | | | |
| | LEO, | | | | | | |
| | non-satellite) | | | | | | |
| | has changed | | | | | | |

NOTE 2:
Applicability of Rx is described in Annex C.
NOTE 3:
UE-DS-TT Residence Time is only provided if a DS-TT port is detected.
NOTE 4:
Bulk subscription is implicit. NOTE 1 does not apply.
NOTE 5:
For a PDU Session established over a SNPN, the combination of the PLMN id and the NID identifies the SNPN.

If an AF requests the PCF to report the PLMN identifier where the UE is currently located, then the PCF shall provide the PLMN identifier or the SNPN identifier to the AF if available. Otherwise, the PCF shall provision the corresponding PCC rules, and the Policy Control Request Trigger to report PLMN change to the SMF. The PCF shall, upon receiving the PLMN identifier or the SNPN identifier from the SMF forward this information to the AF, including the PLMN Id and if available the NID.

If an AF requests the PCF to report on the change of Access Type, the PCF shall provide the corresponding Policy Control Request Trigger to the SMF to enable the report of the Change in Access Type to the PCF. The PCF shall, upon reception of information about the Access Type the user is currently using and upon indication of change of Access Type, notify the AF on changes of the Access Type and forward the information received from the SMF to the AF. The change of the RAT Type shall also be reported to the AF, even if the Access Type is unchanged. For MA PDU Session the Access Type information may include two Access Type information that the user is currently using.

If an AF requests the PCF to report on the signaling path status, for the AF session, the PCF shall, upon indication of removal of PCC Rules identifying signaling traffic from the SMF report it to the AF.

If an AF requests the PCF to report Access Network Charging Correlation Information, the PCF shall provide to the AF the Access Network Charging Correlation Information, which allows to identify the usage reports that include measurements for the Service Data Flow(s), once the Access Network Charging Correlation Information is known at the PCF.

If an AF requests the PCF to report Access Network Information (i.e. the User Location Report and/or the UE Timezone Report) at AF session establishment, modification or termination, the PCF shall set the Access Network Information report parameters in the corresponding PCC rule(s) and provision them together with the corresponding Policy Control Request Trigger to the SMF. For those PCC rule(s) based on preliminary service information the PCF may assign the 5QI and ARP of the QoS Flow associated with the default QoS rule to avoid signaling to the UE. The PCF shall, upon receiving an Access Network Information report corresponding to the AF session from the SMF, forward the Access Network Information as requested by the AF (if the SMF only reported the serving PLMN identifier or the SNPN identifier to the PCF, the PCF shall forward it to the AF). For AF session termination the communication between the AF and the PCF shall be kept alive until the PCF report is received.

If an AF requests the PCF to report the Usage for Sponsored Data Connectivity, the PCF shall provision the corresponding PCC rules, and the Policy Control Request Trigger to the SMF. If the usage threshold provided by the AF has been reached or the AF session is terminated, the PCF forwards such information to the AF.

If an AF requests the PCF to report the Service Data Flow deactivation, the PCF shall report the release of resources corresponding to the AF session. The PCF shall, upon being notified of the removal of PCC Rules corresponding to the AF session from the SMF, forward this information to the AF. The PCF shall also forward, if available, the reason why the resources are released, the user location information and the UE Timezone.

If an AF requests the PCF to report the Resource allocation outcome, the PCF shall report the outcome of the resource allocation of the Service Data Flow(s) related to the AF session. The AF may request to be notified about successful or failed resource allocation. In this case, the PCF shall instruct the SMF to report the successful resource allocation trigger. If the SMF has notified the PCF that the resource allocation of a Service Data Flow is successful and the currently fulfilled QoS matches an Alternative QoS parameter set, the PCF shall also provide to the AF the QoS reference parameter corresponding to the Alternative QoS parameter set referenced by the SMF.

If an AF requests the PCF to report when the QoS targets can no longer (or can again) be fulfilled for a particular media flow, the PCF shall set the QNC indication in the corresponding PCC rule(s) that includes a GBR or delay critical GBR 5QI value and provision them together with the corresponding Policy Control Request Trigger to the SMF. At the time, the SMF notifies that GFBR can no longer (or can again) be guaranteed for a QoS Flow to which those PCC Rule(s) are bound, the PCF shall report to the AF the affected media flow and provides the indication that QoS targets can no longer (or can again) be fulfilled. If additional information is received with the notification from SMF, the PCF shall also provide to the AF the QoS reference parameter corresponding to the Alternative QoS parameter set referenced by the SMF. If the SMF has indicated that the lowest priority Alternative QoS parameter set cannot be fulfilled, the PCF shall indicate to the AF that the lowest priority QoS reference of the Alternative Service Requirements cannot be fulfilled.

If the AF has subscribed to be notified of the QoS Monitoring information, the PCF further sends the QoS Monitoring report to the AF.

If an AF requests the PCF to report on the Out of credit event for the associated service data flow(s), the PCF shall inform the AF (when it gets informed by the SMF) that credit is no longer available for the services data flow(s) related to the AF session together with the applied termination action.

If an AF requests the PCF to report on the Reallocation of credit event for the associated service data flow(s), the PCF shall inform the AF (when it gets informed by the SMF) that credit has been reallocated after credit was no longer available and the termination action was applied for the service data flow(s) related to the AF session.

If an AF requests the PCF to report on the event of the 5GS Bridge information Notification, for the AF session, the PCF shall, request the SMF to report on the trigger of 5GS Bridge information available. Upon reception of the 5GS Bridge information, the PCF forwards this information to the TSN AF.

If the AF requests the PCF to report on the outcome of the service area coverage change, the PCF reports the outcome of the service area coverage change to the AF and notifies the current service area coverage to the AF. The subscription may also be implicit. In this case there may be bulk subscription, either for an Internal-Group-Id or for any UE. In order to prevent massive notifications to the AF, the request for any UE is associated to a specific Application Id or DNN, S-NSSAI. For bulk subscription, when the AF request includes an expiration time, the PCF stops reporting to the AF when the expiration time is reached.

If the AF requests the PCF to report on the outcome of the UE Policies delivery due to service specific parameter provisioning procedure, the PCF reports the outcome of the related UE Policies provisioning procedure for the related traffic descriptor for every involved UE. The subscription is implicit and then there may be bulk subscription, either for an Internal-Group-Id or for any UE. In order to prevent massive notifications to the AF, the request for any UE is associated to a specific Application Id or DNN, S-NSSAI.

If the AF requests the PCF to report on the outcome of AF influence on traffic routing, the PCF reports the outcome of the AF influence on traffic routing for the applicable PDU sessions for every involved UE. The subscription may also be implicit. In this case there may be bulk subscription, either for an Internal-Group-Id or for any UE. In order to prevent massive notifications to the AF, the request for any UE is associated to a specific Application Id or DNN, S-NSSAI. If the AF requests the PCF to report on the outcome of IPTV configuration, the PCF reports the outcome of the IPTV configuration for the applicable PDU sessions for every involved UE. The subscription is implicit and then there may be bulk subscription, either for an Internal-Group-Id or for any UE. In order to prevent massive notifications to the AF, the request for any UE is associated to a specific Application Id or DNN, S-NSSAI.

If the AF requests the PCF to report on the BDT status for concerned PDU session, the PCF reports the event of PDU session establishment over an S-NSSAI/DNN previously negotiated for BDT. The subscription is implicit and then there may be bulk subscription, either for an Internal-Group-Id or for any UE. In order to prevent massive notifications to the AF, the request for any UE is associated to a specific Application Id or DNN, S-NSSAI.

A request to report Start of application traffic detection and Stop of application traffic detection triggers the reporting when the PCF receives start of application traffic detection event or stop of application traffic detection event from SMF. The reception of a subscription to this event triggers the setting of the corresponding Policy Control Request Trigger to SMF, if not already subscribed.

If an AF requests the PCF to report on the change of satellite backhaul, category (i.e. GEO, MEO, LEO, non-satellite) the PCF shall provide the corresponding Policy Control Request Trigger to the SMF to enable the report of the Change in Satellite backhaul category to the PCF. The PCF shall, upon reception of information about the Satellite backhaul category the user is currently using and upon indication of change of Satellite backhaul category, notify the AF on changes of the Satellite backhaul category and forward the information received from the SMF to the AF.

The following relates to the Updates for AF Influence on traffic routing.

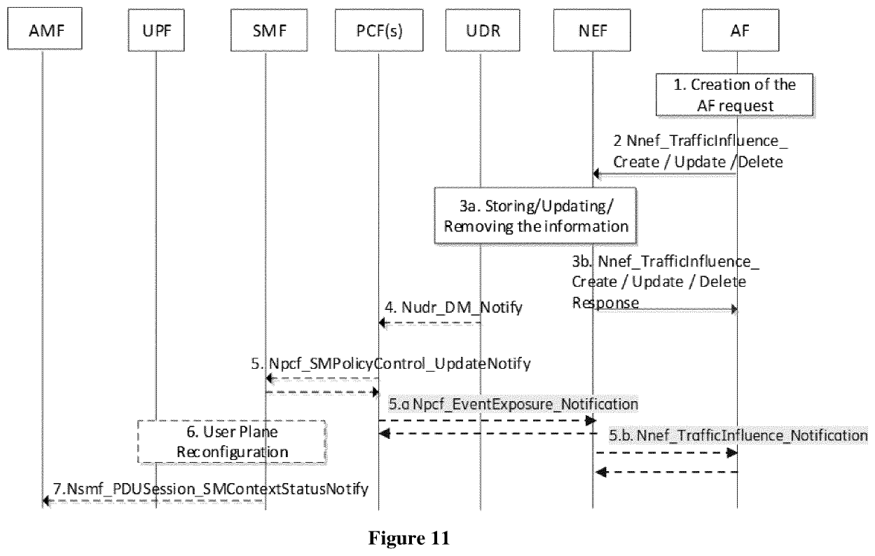

FIG. 11 illustrates a flowchart for a procedure for processing AF requests to influence traffic routing for Sessions not identified by an UE address according to another embodiment of the present invention. The 5GC functions used in this scenario are assumed to all belong to the same PLMN (HPLMN in non-roaming case or VPLMN in the case of a PDU Session in LBO mode). Nnef_TrafficInfluence_Create or Nnef_TrafficInfluence_Update or Nnef_TrafficInfluence_Delete service operations invoked from an AF located in the HPLMN for local breakout and home routed roaming scenarios are not supported. The procedure comprises the following steps:

1. To create a new request, the AF invokes a Nnef_TrafficInfluence_Create service operation. The request contains also an AF Transaction Id. If it subscribes to events related with PDU Sessions the AF indicates also where it desires to receive the corresponding notifications (AF notification reporting information).

To update or remove an existing request, the AF invokes a Nnef_TrafficInfluence_Update or Nnef_TrafficInfluence_Delete service operation providing the corresponding AF Transaction Id.

2. The AF sends its request to the NEF. If the request is sent directly from the AF to the PCF, the AF reaches the PCF selected for the existing PDU Session by configuration or by invoking Nbsf_management_Discovery service.

The NEF ensures the necessary authorization control, including throttling of AF requests and, mapping from the information provided by the AF into information needed by the 5GC.

3. In the case of Nnef_TrafficInfluence_Create or Update: The NEF stores the AF request information in the UDR (Data Set=Application Data; Data Subset=AF traffic influence request information, Data Key=AF Transaction Internal ID, S-NSSAI and DNN and/or Internal Group Identifier or SUPI).

Both the AF Transaction Internal ID and, S-NSSAI and DNN and/or Internal Group Identifier or SUPI are regarded as Data Key when the AF request information are stored into the UDR.

In the case of Nnef_TrafficInfluence_delete: The NEF deletes the AF requirements in the UDR (Data Set=Application Data; Data Subset=AF traffic influence request information, Data Key=AF Transaction Internal ID).

The NEF responds to the AF.

4. The PCF(s) that have subscribed to modifications of AF requests (Data Set=Application Data; Data Subset=AF traffic influence request information, Data Key=S-NSSAI and DNN and/or Internal Group Identifier or SUPI) receive(s) a Nudr_DM_Notify notification of data change from the UDR.

5. The PCF determines if existing PDU Sessions are potentially impacted by the AF request. For each of these PDU Sessions, the PCF updates the SMF with corresponding new PCC rule(s) by invoking Npcf_SMPolicyControl_UpdateNotify service operation.

If the AF request includes a notification reporting request for UP path change, the PCF includes in the PCC rule(s) the information required for reporting the event, including the Notification Target Address pointing to the NEF or AF and the Notification Correlation ID containing the AF Transaction Internal ID.

The PCF may, optionally, use service experience analytics per UP path, to provide an updated list of DNAI(s) to the SMF.

5a. If the AF request includes a notification reporting the outcome of AF Influence on traffic routing request the PCF notifies the NEF including the result of the previous PCC rule update.

5b. When the NEF receives Npcf_EventExposure_Notify, the NEF performs information mapping (e.g. AF Transaction Internal ID provided in Notification Correlation ID to AF Transaction ID, SUPI to GPSI, etc.), and triggers the appropriate Nnef_TrafficInfluence_Notify message.

6. When a PCC rule is received from the PCF, the SMF may take appropriate actions to reconfigure the User plane of the PDU Session. The SMF may consider service experience analytics per UP path (i.e. including UPF and/or DNAI and/or AS instance) before taking such actions. Examples of actions are:
Determining a target DNAI and adding, replacing or removing a UPF in the data path to e.g. act as an UL CL or a Branching Point.
Allocate a new Prefix to the UE (when IPv6 multi-Homing applies).
Updating the UPF in the target DNAI with new traffic steering rules.
Subscribe to notifications from the AMF for an Area of Interest via Namf_EventExposure_Subscribe service operation.

7. When the target DNAI(s) is received from the PCF, the SMF may decide whether it is required to send the target DNAI to the AMF for triggering SMF/I-SMF (re)selection and then inform the target DNAI information for the current PDU session or for the next PDU session to AMF via Nsmf_PDUSession_SMContextStatusNotify service operation.

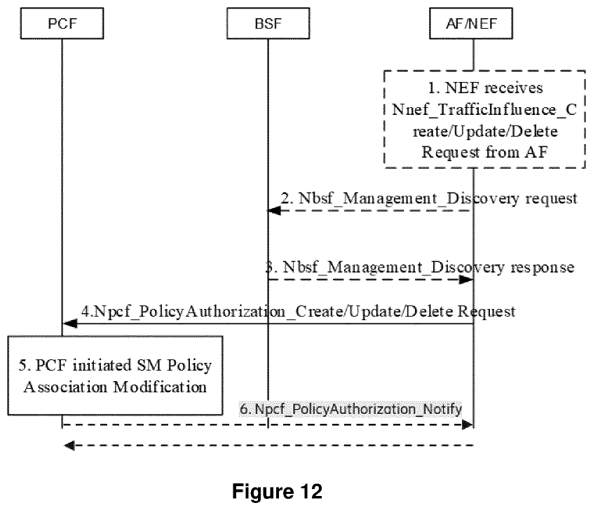

FIG. 12 illustrates a flowchart for a procedure for handling an AF request targeting an individual UE address to the relevant PCF according to another embodiment of the present invention.

Depending on the AF deployment, the AF may send the AF request to PCF directly, in which case step 1 is skipped, or via the NEF. The procedure comprises the following steps:

1. [Conditional] If the AF sends the AF request via NEF, the AF sends Nnef_TrafficInfluenceCreate/Update/Delete Request targeting an individual UE address to the NEF. This request corresponds to an AF request to influence traffic routing that targets an individual UE address.

When NEF receives an AF request from AF, the NEF ensures the necessary authorization control and, mapping from the information provided by the AF into information needed by the 5GC. The NEF responds to the AF.

2. [Conditional] AF/NEF consumes Nbsf_Management_Discovery service operation (providing at least the UE address) to find out the address of the relevant PCF if the PCF address is not available on the NEF based on local configuration, otherwise step 1 is skipped.

Note that the AF/NEF finds the BSF based on local configuration or using the NRF.

3. BSF provides the PCF address in the Nbsf_Management_Discovery response to AF/NEF.

4. If step 1 was performed, NEF invokes the Npcf_PolicyAuthorization service to the PCF to transfer the AF request. If an AF sends the AF request directly to the PCF, AF invokes Npcf_PolicyAuthorization service and the PCF responds to the AF.

5. The PCF updates the SMF with corresponding new PCC rule(s) with PCF initiated SM Policy Association Modification procedure.

6. If the AF has subscribed to outcome of AF Influence on traffic routing procedure events in step 1, the PCF reports the outcome of the procedure to the AF.

The PCF may, optionally, use service experience analytics per UP path, to provide a an updated list of DNAI(s) to the SMF.

When a PCC rule is received from the PCF, the SMF may take appropriate actions, when applicable, to reconfigure the User plane of the PDU Session. The SMF may consider service experience analytics per UP path (i.e. including UPF and/or DNAI and/or AS instance) before taking such actions. Examples of actions are:
Determining a target DNAI and adding, replacing or removing UPF(s) in the data path, e.g. to act as UL CL, Branching Point, and/or PDU Session Anchor.
Allocate a new Prefix to the UE (when IPv6 multi-Homing applies).
Updating the UPF regarding the target DNAI with new traffic steering rules.
Subscribe to notifications from the AMF for an Area of Interest via Namf_EventExposure_Subscribe service operation.

The following relates to the Updates for Set a Policy for a Future AF Session.

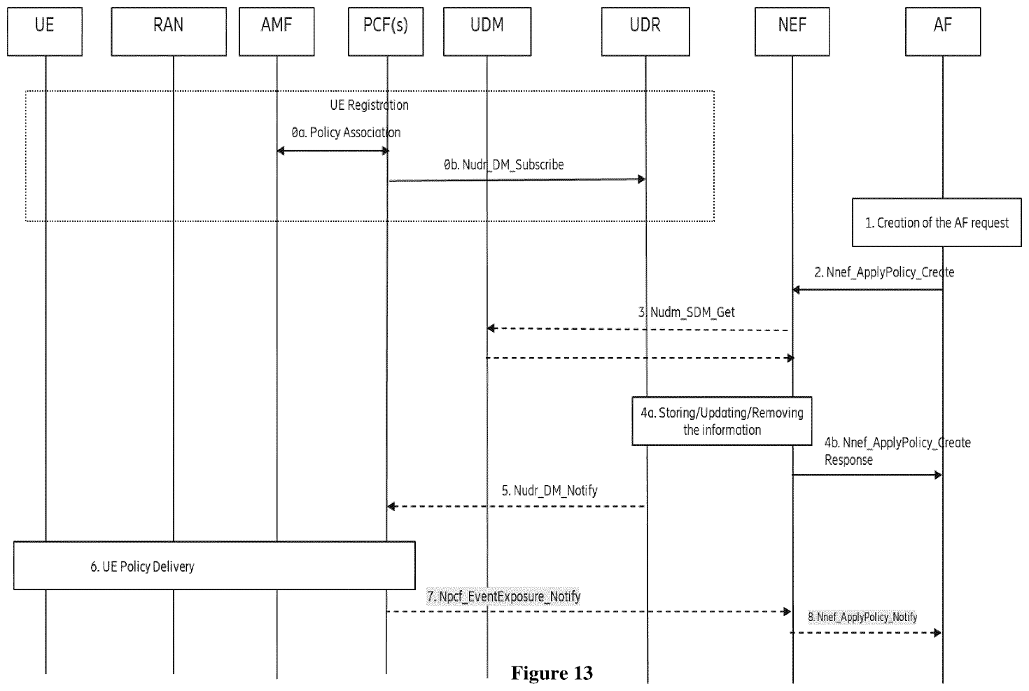

FIG. 13 illustrates a flowchart for a procedure for setting a policy for a future AF session according to another embodiment of the present invention. The procedure comprises the following steps:

0. UE Registration

1. The AF previously negotiated policy for background data transfer using the Procedure for future background data transfer.

2. The AF requests that the previously negotiated policy for background data transfer be applied to a group of UE(s) or any UE, by invoking the Nnef_ApplyPolicy_Create service operation (AF Identifier, External Identifier or External Group Identifier, Background Data Transfer Reference ID). The Background Data Transfer Reference ID parameter identifies a previously negotiated transfer policy for background data transfer. The NEF assigns a Transaction Reference ID to the Nnef_ApplyPolicy_Create request. The NEF authorizes the AF request and stores the AF Identifier and the Transaction Reference ID.

If the AF subscribes to events related with the enforcement of the negotiated BDT policy (i.e., . . . outcome of UE Policy delivery with BDT data and/or BDT Policy status for the concerned PDU session) the AF indicates also where it desires to receive the corresponding notifications (AF notification reporting information).

3. The NEF invokes Nudm_SDM_Get (Identifier Translation, GPSI) to resolve the GPSI (External Identifier) to a SUPI or the NEF requests to resolve the External Group Identifier into the Internal Group Identifier using Nudm_SDM_Get (Group Identifier Translation, External Group Identifier).

4a. The NEF stores the AF request information in the UDR (Data Set=Application Data; Data Subset=Background Data Transfer, Data Key=Internal Group Identifier or SUPI).

4b. The NEF responds to the Nnef_ApplyPolicy_Create Request (Transaction Reference ID).

5. The PCF(s) that have subscribed to modifications of AF requests (Data Set=Application Data; Data Subset=Background Data Transfer, Data Key=Internal Group Identifier or SUPI) receive(s) a Nudr_DM_Notify notification of data change from the UDR.

6. If the AF subscribed to notifications about the outcome of UE Policies delivery due to Set a policy for future session the PCF notifies the outcome of the procedure to NEF sending Npcf_EventExposure_Notify.

7. When the NEF receives Npcf_EventExposure_Notify, the NEF performs information mapping (e.g. AF Transaction Internal ID provided in Notification Correlation ID to AF Transaction ID, SUPI to GPSI, etc.) and triggers the appropriate Nnef_ApplyPolicy_Notify message.

When later on the UE establishes a PDU session according for the URSP rule(s) containing the policies for the BDT traffic, and the PCF creates the SM Policy Association, the PCF checks if the AF subscribed to notifications about the BDT policy status (e.g., TP unknown, TP not active, TP active, TP expired). If it is so, the PCF notifies of the BDT policy status and subsequent changes to the NEF sending the Npcf_EventExposure_Notify. When the NEF receives the Npcf_EventExposure_Notify, the NEF performs information mapping and triggers the appropriate Nnef_ApplyPolicy_Notify message.

The following relates to the Nnef_ApplyPolicy_Create service operation.

Service operation name: Nnef_ApplyPolicy Create

Description: The consumer requests to apply a policy to the UE.

Inputs, Required: AF Identifier, External Identifier or External Group ID, Background Data Transfer Reference ID for a previously negotiated policy of a background data transfer.

Inputs, Optional: subscribedEvents, notificationDestination

Outputs, Required: Transaction Reference ID, result.

Output (optional): None.

The following relates to the Nnef_ApplyPolicy_Notify operation.

Service operation name: Nnef_ApplyPolic_Notify

Description: Forwards the notification of outcome of UE Policies Delivery to AF.

Inputs, Required: Transaction Reference ID, GPSI/SUPI, Result.

The Transaction Reference ID identifies the AF request for set a policy for a future session that the event report is related to. The event Id may be the UE Policies delivery outcome and/or BDT Policy status for the concerned PDU session. The GPSI/SUPI is the identifier of the UE for which the event report is related to. The Result is the result of the UE Policies delivery procedure and/or BDT Policy status for the concerned PDU session for which event report is related to.

Inputs, Optional: DNN, S-NSSAI. additional event info (e.g. for unsuccessful results the reason).

Outputs, Required: Operation execution result indication

Outputs, Optional: None

The following relates to Updates for AF request to configure IPTV multicast control.

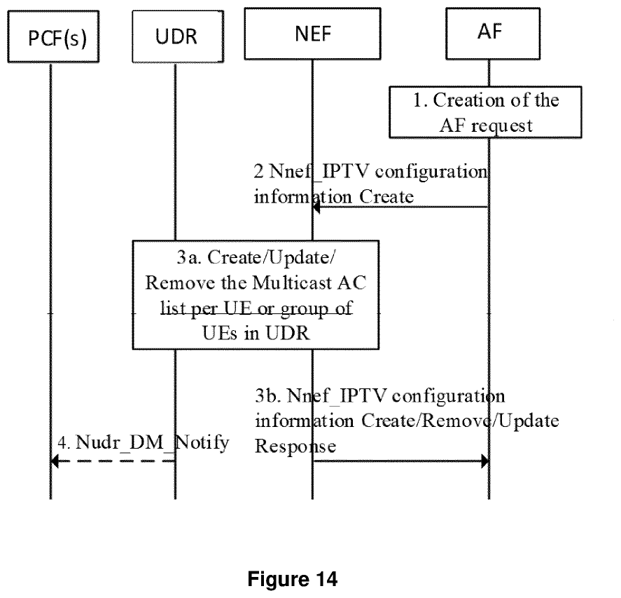

FIG. 14 illustrates a flowchart for a procedure for AF request to provision multicast access control list information into UDR.

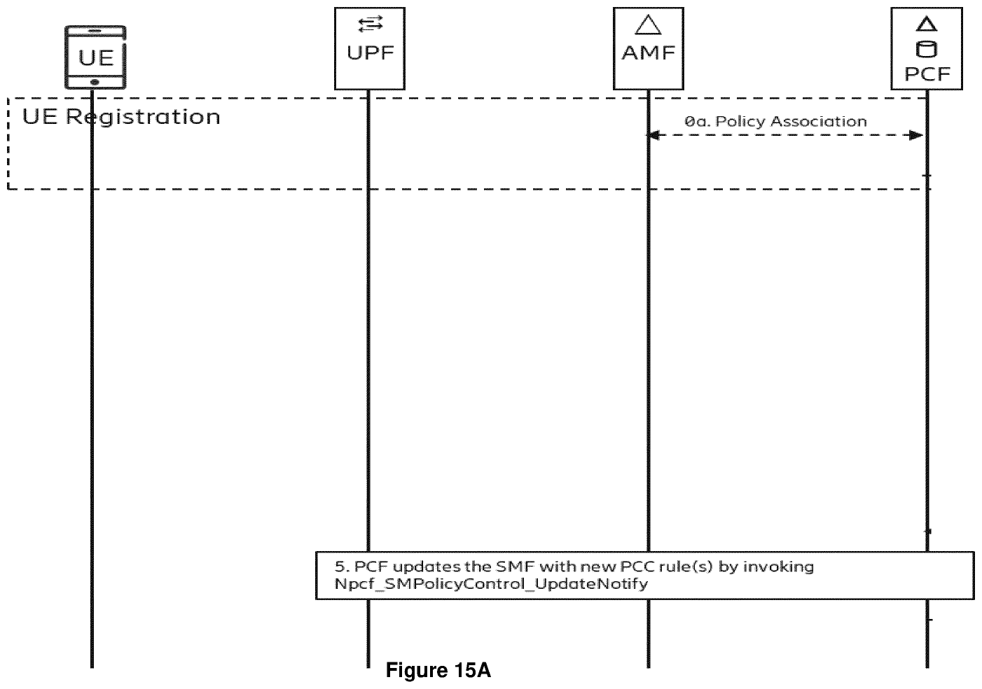

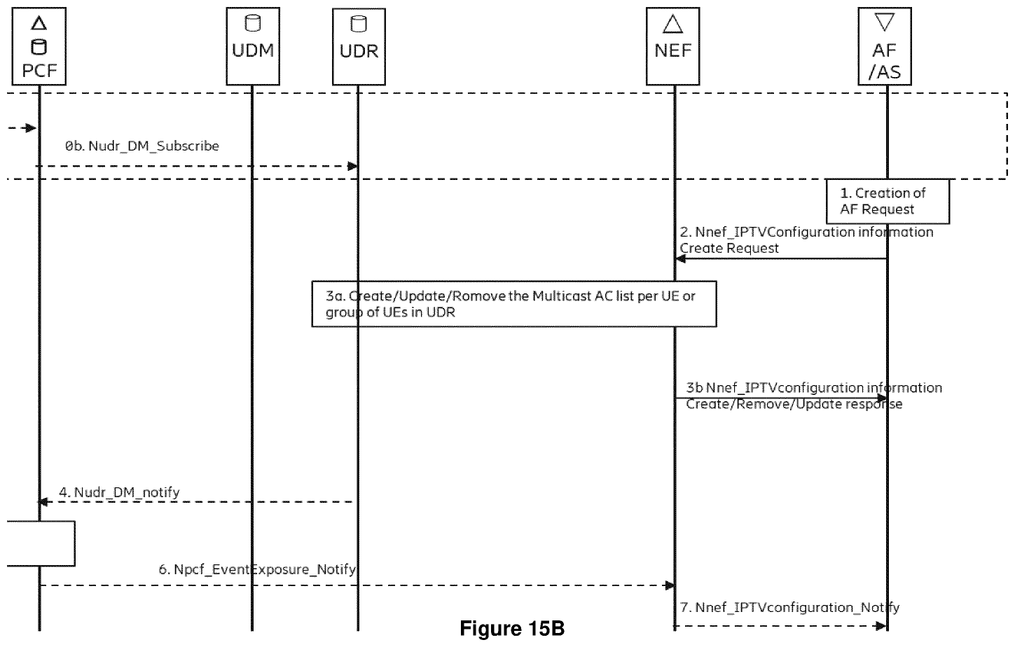

FIGS. 15A and 15B illustrate a flowchart for a procedure for AF request to provision Multicast Access Control List information into UDR according to another embodiment of the present invention. The 5GC NFs used in this scenario are assumed to all belong to the same PLMN (HPLMN).

The procedure comprises the following steps:

1. To create a new request, the AF invokes an Nnef_IPTV_configuration service operation. The request contains the Multicast Access Control List, a GPSI or an External Group Id, AF Transaction Id, application identifier and may contain a DNN and/or a S-NNSAI. To update or remove an existing request, the AF invokes Nnef_IPTV_configuration_Update or Nnef_IPTV_configuration_Delete service operation providing the corresponding AF Transaction Id.

If the AF subscribes to events related with the outcome of the AF request to configure IPTV multicast control the AF indicates also where it desires to receive the corresponding notifications (AF notification reporting information)

2. The AF sends its request to the NEF. The NEF ensures the necessary authorization control, including throttling of AF requests and, mapping from the information provided by the AF into information needed by the 5GC.

3. In the case of Nnef_IPTV_configuration_Create or Update): The NEF stores the AF request information in the UDR (Data Set=Application Data; Data Subset=IPTV_configuration, Data Key=AF Transaction Internal ID, S-NSSAI and DNN and/or SUPI/Internal-Group-Id).

In the case of Nnef_IPTV_configuration_Delete): The NEF deletes the AF requirements in the UDR (Data Set=Application Data; Data Subset=IPTV_configuration, Data Key=AF Transaction Internal ID).

The NEF responds to the AF.

4. The PCF(s) that have subscribed to modifications of AF requests (Data Set=Application Data; Data Subset=IPTV_configuration, Data Key=SUPI/Internal-Group-Id) receive a Nudr_DM_Notify notification of data change from the UDR.

5. The PCF determines if existing PDU Sessions are potentially impacted by the AF request. For each of these PDU Sessions, the PCF updates the SMF with corresponding new PCC rule(s) by invoking Npcf_SMPolicyControl_Update Notify service operation.

6. If the AF subscribed to notifications about the outcome of IPTV configuration, the PCF notifies the outcome of the procedure to NEF sending Npcf_EventExposure_Notify.

7. When the NEF receives Npcf_EventExposure_Notify, the NEF performs information mapping (e.g. AF Transaction Internal ID provided in Notification Correlation ID to AF Transaction ID, SUPI to GPSI, etc.) and triggers the appropriate Nnef_IPTVconfiguration_Notify message.

Table 4 shows an example of a Multicast Access Control list provided by the AF in the IPTV domain to the NEF. The Multicast Access Control List defines the access right status (i.e. fully allowed, preview allowed, not allowed) of each of the Multicast channels per subscriber identified by a GPSI.

TABLE 4
Example of a Multicast Access Control list
provided by the AF in the IPTV domain

| | IP Multicast | IP Multicast | IP Multicast |
|---|---|---|---|
| | Addressing | Addressing | Addressing |
| | information 1 | information 2 | information |
| | (related to | (related to | 3 (related to |
| | Channel 1) | Channel 2) | Channel 3) |
| GPSI 1 | Fully allowed | Not allowed | Preview allowed |

The NEF maps the GPSI into the SUPI, assigned to a 5G-RG, as described in step 2 in FIG. 14. and stores the Multicast Access Control List in the UDR as shown in Table 5.

TABLE 5
Example of a Multicast Access Control list
stored in UDR within the Application Data Set

| | IP Multicast | IP Multicast | IP Multicast |
|---|---|---|---|
| | Addressing | Addressing | Addressing |
| | information 1 | information 2 | information 3 |
| | (related to TV | (related to TV | (related to TV |
| DataKey | Channel 1) | Channel 2) | Channel 3) |
| SUPI for 5G-RG 1 | Fully allowed | Not allowed | Preview allowed |
| SUPI for 5G-RG 2 | Fully allowed | Fully allowed | Not allowed |
| SUPI for 5G-RG 3 | Fully allowed | Preview allowed | Preview allowed |

If source Specific Multicast is to be used for a TV Channel, IP Multicast Addressing information corresponds to IP Multicast address and Source IP address.

The PCF is assumed to have subscribed to relevant modifications of that UDR data defined in the Table 5.

The following relates to the Nnef_IPTVconfiguration_Create operation.

Service operation name: Nnef_IPTVconfiguration_Create

Description: Authorize the request and forward the request for IPTV configuration information.

Inputs (required): AF Transaction Id, GPSI or External-Group-ID, application identifier, Multicast Access Control List.

The AF Transaction Id refers to the request.

Inputs (optional): DNN, S-NSSAI, subscribedEvents, NotificationAddress

Outputs (required): Operation execution result indication.

Outputs (optional): None.

The following relates to the Nnef_IPTVconfiguration_Notify operation.

Service operation name: Nnef_IPTVconfiguration_Notify

Description: Forwards the notification of outcome of IPTV configuration information to AF.

Inputs, Required: Transaction Reference ID, GPSI/SUPI, Result.

Inputs, Optional: additional event info (e.g. for unsuccessful results the reason).

Outputs, Required: Operation execution result indication

Outputs, Optional: None

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the scope of the disclosure as those skilled in the art readily understand. Such modifications and variations are considered to be within the scope of the disclosure and the appended claims. The protection scope of the disclosure is defined by the accompanying claims.

1.-53. (canceled)

54. A method for delivering Session Management (SM) or User Equipment (UE) policy in a 3GPP core network comprising the following steps performed by a first network node:
sending, to a second network node, a request for delivering the SM or the UE policy, wherein the request indicates a subscription to the outcome of the SM or the UE policy delivery; and
receiving, from the second network node, an outcome of the SM or the UE policy delivery.

55. The method according to claim 54, wherein the first network node is an Application Function (AF) node, and the second network node is a Network Exposure Function (NEF) node.

56. The method according to claim 55 wherein the delivery is of a UE policy, and the request is sent to the NEF node and includes:
service specific parameters to be provisioned in the 3GPP core network;
service description for identifying a service which the service specific parameters are applied to;
target UE(s) indicating a UE or a group of UEs which the service specific parameters shall be delivered to by a Policy Control Function (PCF) node; and
subscription to a notification on an outcome of UE policy delivery procedure as the outcome of configuring the UE policy.

57. The method according to claim 55, wherein the delivery is of a UE Route Selection Policy (URSP), and the request is sent to the NEF node and includes:
service description for identifying an AF;
service parameters on application guidance for URSP determination;
a UE, a group of UEs or any UE which the request is associated with; and
subscription to a notification on an outcome of URSP delivery procedure as the outcome of configuring the SM or the UE policy.

58. The method according to claim 57, wherein the service parameters consist of a list of rules that associate an application traffic descriptor with requested features for PDU session(s) used by an application traffic.

59. The method according to claim 58, wherein the service parameters including: an application traffic descriptor corresponding to URSP Traffic Descriptor; and
one or more sets of Route selection parameters, each corresponds to:
(DNN, S-NSSAI) provided by the first network node or determined by the second network node based on an AF Identifier;
a default Route selection precedence value to be used for an application traffic when Route selection precedence with a corresponding spatial validity condition is not provided;
route selection precedence with the corresponding spatial validity condition that indicates where the Route selection parameters are applied.

60. The method according to claim 55, wherein the delivering is used for any one of:
AF influence on traffic routing, and the request is sent to the NEF node or a PCF node and includes:
subscription to a notification on an outcome of Policy Control Charge (PCC) rule installation procedure for user plane reconfiguration as the outcome of configuring the SM or the UE policy; and
an indicator on where the first network node desires to receive the notification;
setting a Background Data Transfer (BDT) policy for a future AF session, and the request is sent to the NEF node and includes:
subscription to a notification on status of the BDT policy as the outcome of configuring the SM or the UE policy; and
an indicator on where the first network node desires to receive the notification; or
configuring IPTV multicast control, and the request is sent to the NEF node and includes:
subscription to a notification on an outcome of PCC rule installation procedure for IPTV configuration as the outcome of configuring the SM or the UE policy; and
an indicator on where the first network node desires to receive the notification.

61. A first network node for delivering Session Management (SM) or User Equipment (UE) policy in a 3GPP core network, comprising:
at least one processor; and
a memory containing program code executable by the at least one processor,
whereby execution of the program code by the at least one processor causes the first network node to:
send, to a second network node, a request for delivering the SM or the UE policy, wherein the request indicates a subscription to the outcome of the SM or the UE policy delivery; and
receive, from the second network node, an outcome of the SM or the UE policy delivery.

62. The first network node according to claim 61, wherein the first network node is an Application Function (AF) node, and the second network node is a Network Exposure Function (NEF) node.

63. A method for delivering Session Management (SM) or User Equipment (UE) policy in a 3GPP core network, comprising the following steps performed by a first network node:
receiving, from a second network node, a request for delivering the SM or the UE policy, wherein
the request indicates a subscription to the outcome of the SM or the UE policy delivery;
receiving, from a third network node, an outcome of the SM or the UE policy delivery; and
forwarding the outcome of the SM or the UE policy delivery to the second network node.

64. The method according to claim 63, wherein the first network node is a Network Exposure Function (NEF) node, the second network node is an Application Function (AF) node, and the third network node is a Policy Control Function (PCF) node.

65. The method according to claim 64, wherein the step of forwarding comprises:
performing information mapping from a notification on the outcome of the SM or the UE policy delivery sent from the third network node so as to determine the AF node that subscribed to the notification; and
sending the notification to the AF node.

66. The method according to claim 64, wherein the delivering is used for service specific parameter provision and the outcome of delivering the SM or the UE policy is an outcome of UE policy delivery procedure, the method further comprising:
upon receiving the request, storing information of the request in a Unified Data Repository (UDR) node for being used by the third network node.

67. The method according to claim 64, wherein the delivery is of a UE Route Selection Policy (URSP), and the outcome of delivering the SM or the UE policy is an outcome of URSP delivery procedure, the method further comprising:
upon receiving the request, complementing missing service parameters in the request based on local configuration.

68. The method according to claim 64, wherein the delivering is used for any one of:
AF influence on traffic routing and the outcome of configuring the SM or the UE policy is an outcome of Policy Control Charge (PCC) rule installation procedure for user plane reconfiguration, the method further comprising:
upon receiving the request, storing information of the request in a Unified Data Repository (UDR) node for being used by the third network node;
setting a Background Data Transfer (BDT) policy for a future AF session and the outcome of configuring the SM or the UE policy is status of the BDT policy, the method further comprising:
upon receiving the request, storing information of the request in a Unified Data Repository (UDR) node for being used by the third network node; or
configuring IPTV multicast control and the outcome of configuring the SM or the UE policy is an outcome of PCC rule installation procedure for IPTV configuration.

69. A first network node for delivering Session Management (SM) or User Equipment (UE) policy in a 3GPP core network, comprising:
at least one processor; and
a memory containing program code executable by the at least one processor,
whereby execution of the program code by the at least one processor causes the first network node to:
receive, from a second network node, a request for delivering the SM or the UE policy, wherein the request indicates a subscription to the outcome of the SM or the UE policy delivery;
receive, from a third network node, an outcome of the SM or the UE policy delivery; and
forward the outcome of the SM or the UE policy delivery to the second network node.

70. The first network node according to claim 69, wherein the first network node is a Network Exposure Function (NEF) node, the second network node is an Application Function (AF) node, and the third network node is a Policy Control Function (PCF) node.

71. A method for delivering Session Management (SM) or User Equipment (UE) policy in a 3GPP core network, comprising the following steps performed by a first network node:
detecting whether an event related to the SM or the UE policy delivery occurs;
if the event occurs, generating a notification on an outcome of the SM or the UE policy delivery, particularly wherein the method further comprises
receiving, from a second network node or a third network node, a request for delivering the SM or the UE policy, wherein the request indicates a subscription to the outcome of the SM or the UE policy delivery;
and
sending the notification to the second network node or the third network node.

72. The method according to claim 71, wherein the first network node is a Policy Control Function (PCF) node, the second network node is an Application Function (AF) node, and the third network node is a Network Exposure Function (NEF) node.

73. The method according to claim 71, wherein the delivering is used for service specific parameter provision and the outcome of delivering the SM or the UE policy is an outcome of UE policies delivery procedure; or
wherein the delivery is of a UE Route Selection Policy (URSP), and the outcome of the SM or the UE policy delivery is an outcome of URSP delivery procedure.

74. A first network node for delivering Session Management (SM) or User Equipment (UE) policy in a 3GPP core network, comprising:
at least one processor; and
a memory containing program code executable by the at least one processor,
whereby execution of the program code by the at least one processor causes the first network node to:
detect whether an event related to the SM or the UE policy delivery occurs;
if the event occurs, generate a notification on an outcome of the SM or the UE policy delivery, particularly wherein the execution of the program code by the at least one processor further causes the first network node to:
receive from a second network node or a third network node, a request for delivering the SM or the UE policy, wherein the request indicates a subscription to the outcome of the SM or the UE policy delivery;
and
send the notification to the second network node or the third network node.

75. The first network node according to claim 74, wherein the first network node is a Policy Control Function (PCF) node, the second network node is an Application Function (AF) node, and the third network node is a Network Exposure Function (NEF) node.
